(19) United States
(12) Patent Application Publication
(10) Pub. No.: US 2009/0322874 A1
(43) Pub. Date: Dec. 31, 2009

(54) SYSTEM AND METHOD FOR REMOTE SURVEILLANCE

(76) Inventors: Mark Knutson, Puyallup, WA (US); Robert Holliday, Bainbridge Island, WA (US)

Correspondence Address: BLACK LOWE & GRAHAM, PLLC, 701 FIFTH AVENUE, SUITE 4800, SEATTLE, WA, 98104, US

(21) Appl. No.: 12/108,414

(22) Filed: Apr. 23, 2008

Related U.S. Application Data
(60) Provisional application No. 60/913,507, filed on Apr. 23, 2007.
(60) Provisional application No. 60/938,614, filed on May 17, 2007.

(51) Int. Cl. H04N 7/18

(52) U.S. Cl. 348/143; 348/E07.085

(57) ABSTRACT

A remote camera system having a view of a surveilled space is equipped with microprocessors to wirelessly convey encrypted, full motion digital images of the surveilled space to a monitoring network remotely separated from the surveilled space. The monitoring network includes analog and/or digital displays that may be fixed, in mobile vehicles, or be hand held personal digital assistants.

### CROSS REFERENCES TO RELATED APPLICATIONS

This application claims priority to and incorporates by reference in their entireties U.S. Provisional Patent Application Nos. 60/913,507 filed Apr. 23, 2007, and 60/938,614 filed May 17, 2007.

### FIELD OF THE INVENTION

Embodiments of the invention relate generally to systems and methods to conduct remote surveillance, more particularly to those surveillance operations concerned with public safety.

### BACKGROUND OF THE INVENTION

Predecessor surveillance systems are limited in their abilities to remotely record, store, and transmit digital-based images suitable for evidentiary purposes. Available digital players, for example the standard video viewing software, such as RealPlayer™ or Microsoft® Media Player™, does not suitably lend itself to perform the required audit functions that are deemed necessary for law enforcement use. Additionally, vendors update their programs periodically and often lack backwards compatibility with no guarantee that a CD made for a court case will necessarily be playable on the court's computer.

### SUMMARY OF THE PARTICULAR EMBODIMENTS

A system and method to remotely acquire, store, and access still and full motion digitally stored images from a surveilled space. Systems include at least one remote camera equipped with electronics and microprocessors to acquire, store, encrypt, and wirelessly transmit full motion and still images having sufficient resolution to meet evidentiary standards. The stored and encrypted digital images can be remotely accessed by a remote monitoring sub-system. The remote monitoring system can wirelessly access the digital images from stationary, mobile, or hand-held portable displays.

### BRIEF DESCRIPTION OF THE DRAWINGS

Preferred and alternative embodiments of the present invention are described in detail below with reference to the following drawings:

FIG. 1 pictographically depicts an embodiment of a remote surveillance system having a view of a crime scene in two-way signal communication with headquarters via cellular-based wireless, non-cellular wireless, and wired communication using the Internet under live and historic viewing scenarios;

FIG. 2 pictographically depicts an alternate embodiment of a remote surveillance system having a view of a crime scene in two-way signal communication with headquarters via cellular-based wireless, non-cellular wireless and wired communication under live and historic viewing scenarios;

FIG. 3 pictographically depicts an alternate embodiment of a remote surveillance system having a view of a crime scene in two-way signal communication with mobile vehicles via cellular-based and non cellular-based wireless communication under live and historic viewing scenarios;

FIG. 4 pictographically depicts an alternate embodiment of a remote surveillance system having a view of a crime scene in two-way signal communication with mobile vehicles via cellular-based and non cellular-based wireless communication, and separate non-cellular based communications, under live and historic viewing scenarios;

FIG. 5 pictographically depicts an alternate embodiment of a remote surveillance system having a view of a crime scene in two-way signal communication with a mobile vehicles via non cellular-based wireless communication under a live viewing scenario, and cellular-based wireless, non cellular-based wireless, and wired communication with headquarters under an historic viewing scenario;

FIG. 6 pictographically illustrates a plurality of evidentiary displays obtained from digital files of the 2:00 AM crime scene;

FIGS. 7A-7S depict work-up screen shot templates for a portable computer interface;

FIGS. 8-12 depict particular screen shot embodiments of computer and browser interfaces;

FIGS. 13A-13J depict work-up screen shot templates for a browser interface; and

FIGS. 14A-14F depicts particular screen shot embodiments of a systems administrator user interface.

### DETAILED DESCRIPTION OF THE PARTICULAR EMBODIMENTS

The system hardware and software components are unique and designed specifically to support public safety surveillance applications in which a space is remotely observed by cameras and camera images obtained therein are digitally stored having sufficient resolution and under protocols to meet evidentiary standards. Image storage protocols provide a chain-of-custody data management and a built-in audit trail history to image files remotely accessed and/or retrieved by authorized personnel for off site or on site viewing.

The system's remote image acquisition and evidentiary storage protocols provides a force multiplier effect in an effort to find a way to offset the sharply increasing workload of the field officer. Remote accessing and/or retrieval for on site viewing (viewing within or closely nearby the surveilled space) or off site away from the surveilled space can utilize a cellular network configured with adequate data bandwidth. Images viewed by the authorized personnel can utilize microprocessor based devices equipped with the Intel® Core DuO™ processor or the AMD® 64 Athlon™ 64 processor that enable a continuous background video capture process while enabling full-speed, near-real-time control activities from the same processor.

Alternate embodiments for the cellular network can include WCDMA and EV-DO bandwidths. The Wideband Code Division Multiple Access (WCDMA) cellular network delivers approximately 152.6 Kb/s data rates, for example, and is roughly comparable to digital subscriber line DSL speeds. The Evolution-Data Optimized (EV-DO) permits video acquisition and play back to the field officer at rates better than 500 Kb/s, for example. Other alternate embodiments for the cellular networks include revision upgrade to the EV-DO standard, specifically Revision A. Thus the alternate system embodiments provide to the local jurisdiction or region can be served by the Revision A EV-DO that will enable full-motion, full-featured, recorded and/or live video dissemination of the remotely surveilled space.

Embodiments of the remote surveillance system are adaptable for use by village, city, regional or other governmental or authorized private entities to provide a rapidly deployable, mobile, wireless video and audio communications network to increase drug interdiction and address other activities occurring in high crime areas. Mobile video will work as a force multiplier, crime deterrent, and will significantly enhance our ability to respond to community requests for special focus crime prevention. The emphasis will be on enabling patrol officers and special operations teams to quickly set up a surveillance system that can be observed remotely, as needed. These images will be viewable from designated monitoring stations and have the flexibility to support multiple agencies.

The system will enable law enforcement to connect into both public and private sector surveillance systems. This will aid in the detection, intervention, investigation, and prosecution of criminal activity. Officers will have mobile video equipment that can be placed on the dash of their car, carried with them, or left on location. These images can be transmitted to the officer's laptop and/or a command center, as well as shared by other officers involved in the event. Drug trafficking areas, domestic violence locations, construction sites, and many other areas of interest will be temporarily monitored, as requested. Video surveillance “kits” would also be available for use for search warrant and SWAT surveillance—before, during and post-event—and would be used in situations where event monitoring is necessary. For example, the video surveillance kits may include rapidly deployable cameras with wireless communication ability to convey and store digital images onto digital storage mediums. Live and stored digital images enable remote monitoring of present time and historic viewing of surveilled or examined spaces from nearby structures or vehicles having viewing displays in wireless communication with the digital storage mediums or the rapidly deployable cameras. Thus, monitoring could be done from a tactical van, via a handheld device or multiple handheld devices, and/or from a precinct, headquarters, or communication center, allowing for viewing from a distance in stationary environments or in moving environments of an approaching vehicle, thereby increasing officer safety.

General scenarios illustrated below concern remote monitoring of designated spaces of interest, including known or suspected crime scenes or areas demonstrating or suspected to harbor threats to public safety and security. Scenarios include but are not limited to: 1. Citizens observe drug trafficking, but by the time law enforcement is notified and can respond, the offenders are gone. Mobile video will enable remote surveillance of a designated area, allowing officers to observe and respond much more quickly; 2. Business parks have been the targets of criminal activity. The community has requested more patrol to act as a deterrent. Since resources are limited, officers can strategically place cameras around the area and continue patrolling their current assignment but be able to observe late night activity and respond as needed; 3. Construction sites often have equipment and materials stolen in the night. Placing a mobile video camera at the work site will allow officers to respond immediately as thefts occur; 4. Domestic violence offenders often return to threaten victims, but leave before officers can respond. Having a mobile video unit available will give citizens an opportunity to allow surveillance of their location, if desired, and provide an immediate notification and timely intervention by law enforcement; 5. Major incident responses often tax the resources of emergency responders. For example, at 4:30 a.m. a container off-loaded from a ship explodes. The first units to respond are overcome by a chemical odor. Several individuals are reported dead near the site. A quick response video surveillance team installs four linked wireless cameras around the site at safe locations. Managers at the incident command post are quickly able to see all areas in and around the explosion site in a remote controlled live video environment. The cameras begin in a low light setting supplemented by forward-looking infrared (FLIR) imagery until dawn allows for full color video.

Other embodiments of the remote surveillance systems include the ability to capture video/audio from a wireless camera by police or designated personnel, the camera's focus and frame a field of view by lens zooming, and to control when to make their camera's images available to authorized personnel. Image access includes the ability to store, pan through, and freeze frame video images and to extract audio information. Image recording includes digital storage of image and associated audio files, and further includes the ability to capture tabular data associated with each video session. Executable software for setting up, receiving video images, processing video images, and storing images in a variety of formats are accomplished by a computer executable program that may be referred to as WATCHER. How the WATCHER program functions are described in screenshot depictions in the descriptions and figures below.

The remote surveillance system also includes the ability to capture tabular data associated with each video session and to display video/audio from any wireless laptop computer by police officers, command, or other authorized personnel. The ability to search and select available video systems whether they are operating from a mobile or stationary environment is another embodiment functionality of the system. Alternate embodiments for the remote surveillance system include MS SQL Server, a IIS, a 14 TB NAS subsystem, XP and Windows 2000 Clients, a 100 MB Ethernet LAN and DS3 Internet connectivity, a Cisco PIX firewall, a MS Active Directory and Novell Directory Services. The mobile component of the remote surveillance system can include XP and Windows 2000 Laptops, GPRS/G3 air cards, Cisco and NetMotion VPN.

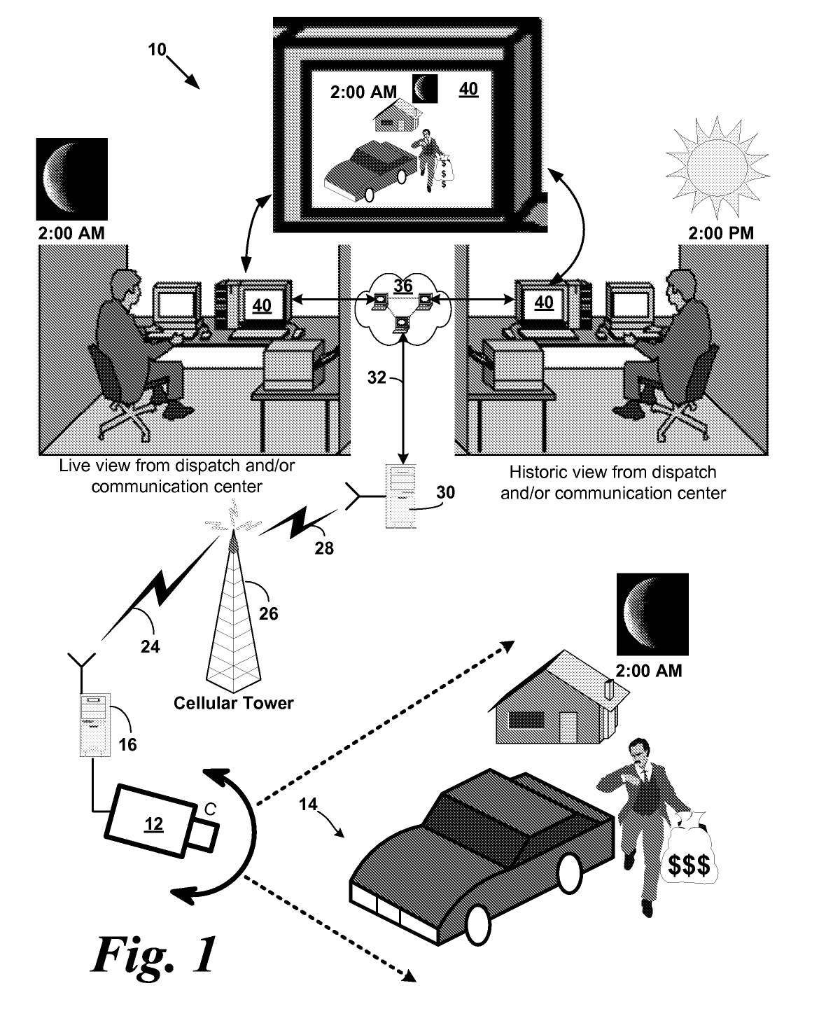

FIG. 1 pictographically depicts an embodiment of a remote surveillance system having a view of a crime scene in two-way signal communication with headquarters via cellular-based wireless, non-cellular wireless, and wired communication using the Internet under live and historic viewing scenarios. The camera includes tilt, pan, and zoom (TPZ) functionality so that different viewing angles and fields of view may be obtained by the surveilled scene or space. A remote control system 10 includes at least one tilt pan and zoom (TPZ) camera 12 with rotational view of a monitored space 14. Other TPZ cameras 12 can be positioned as needed to expand the viewing range or acquire additional details in depth of the surveilled or monitored space 14. If suspected criminal activity is exhibited or otherwise indicated, the monitored space may be referred to as a crime scene 14. The surveillance scene or monitored space 14 depicted in this example illustrates an indicated crime in progress showing a robber with a sack of money fleeing from a house to a getaway car during a 2:00 AM timeframe designated by the crescent Moon. The live view of the crime scene 14 is conveyed from the at least one TPZ camera 12 to a near-scene storage computer 16 for storage. The near-scene computer 16 is equipped for subsequent wireless transmission. Video image and/or any audio content stored within the near-scene computer 16 are relayed via wireless signal 24 to a cellular tower 26. The cellular tower 26 sends the images and any audio content of the live crime scene 14 to a digital computer receiver 30 configured to send digital information content of the crime scene 14 by wired connection 32 to the Internet 36 in signal communication with a dispatch or communication center's computer 40. Personnel controlling the dispatch computer 40 can view the surveillance scene or monitored space 14 under live or present time, in this case at 2:00 AM. Alternatively, dispatch personnel controlling the computer 40 can retrieve stored images of the 2:00 AM crime or surveillance scene 14 from the computer 16 via the wireless signals 24 and 28 to view the 2:00 AM crime or surveillance scene 14 after the fact, or historically, depicted with a Sun on the right at 2:00 PM during the day.

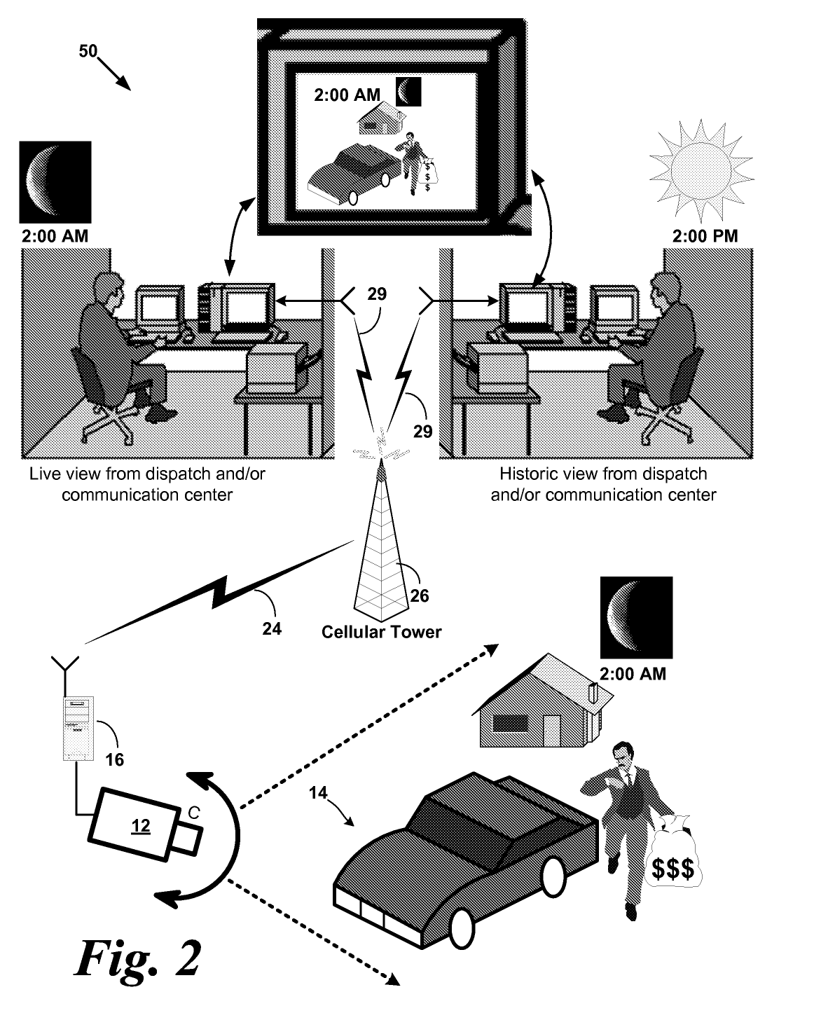

FIG. 2 pictographically depicts an alternate embodiment of a remote surveillance system having a view of a crime scene in two-way signal communication with headquarters via cellular-based wireless, non-cellular wireless and wired communication under live and historic viewing scenarios. System 50 includes direct cellular tower communication with the dispatch computer 40 wireless signals 29 to permit either live or historic viewing of the 2:00 AM crime scene 14.

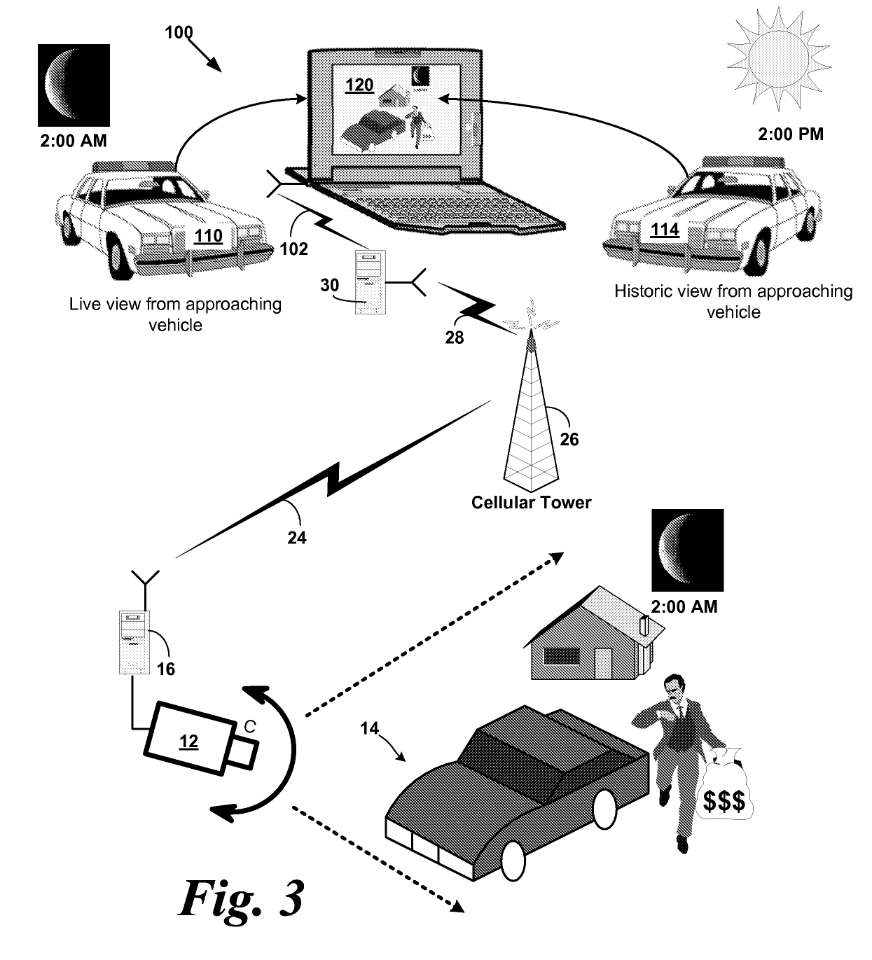

FIG. 3 pictographically depicts an alternate embodiment of a remote surveillance system having a view of a crime scene in two-way signal communication with mobile vehicles via cellular-based and non cellular-based wireless communication under live and historic viewing scenarios. System 100 includes two police vehicles 100 and 114, each having a laptop computer 120 capable of receiving wireless communication via wireless signal 102 transmitted by the digital computer receiver 30 to view either images of the live crime scene 14 or to view the crime scene historically. In this scenario, the police vehicle 110 approaches the crime scene 14 while the crime is in progress, and police vehicle 114 approaches the crime scene to view the crime historically, or after-the-fact. The laptop computer 120 can also be in the form of a personal digital assistant (PDA) or tablet PC.

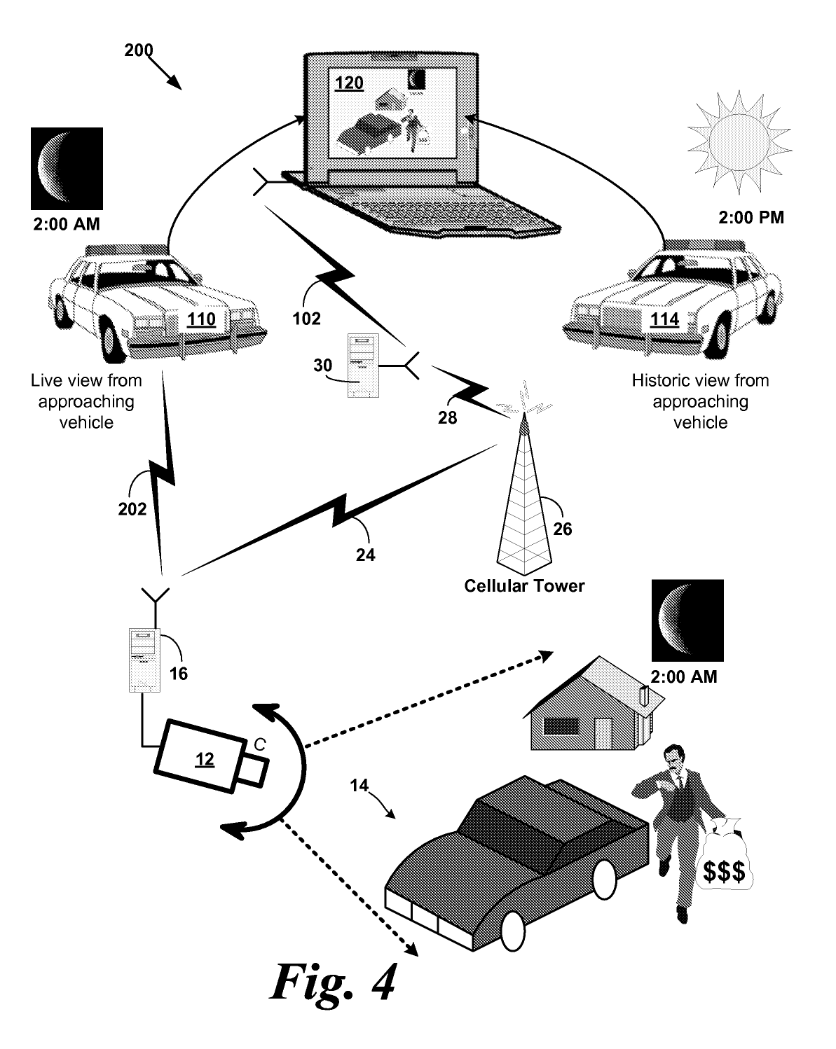

FIG. 4 pictographically depicts an alternate embodiment of a remote surveillance system having a view of a crime scene in two-way signal communication with mobile vehicles via cellular-based and non cellular-based wireless communication, and separate non-cellular based communications, under live and historic viewing scenarios. System 200 is substantially similar to system 100, but also provides for direct communication of the police vehicle 110 with the near-scene storage computer 16 to retrieve live, present time images, or historic recorded images directly and independent of the cellular tower 26 via wireless signal 202 from the near-scene computer 16.

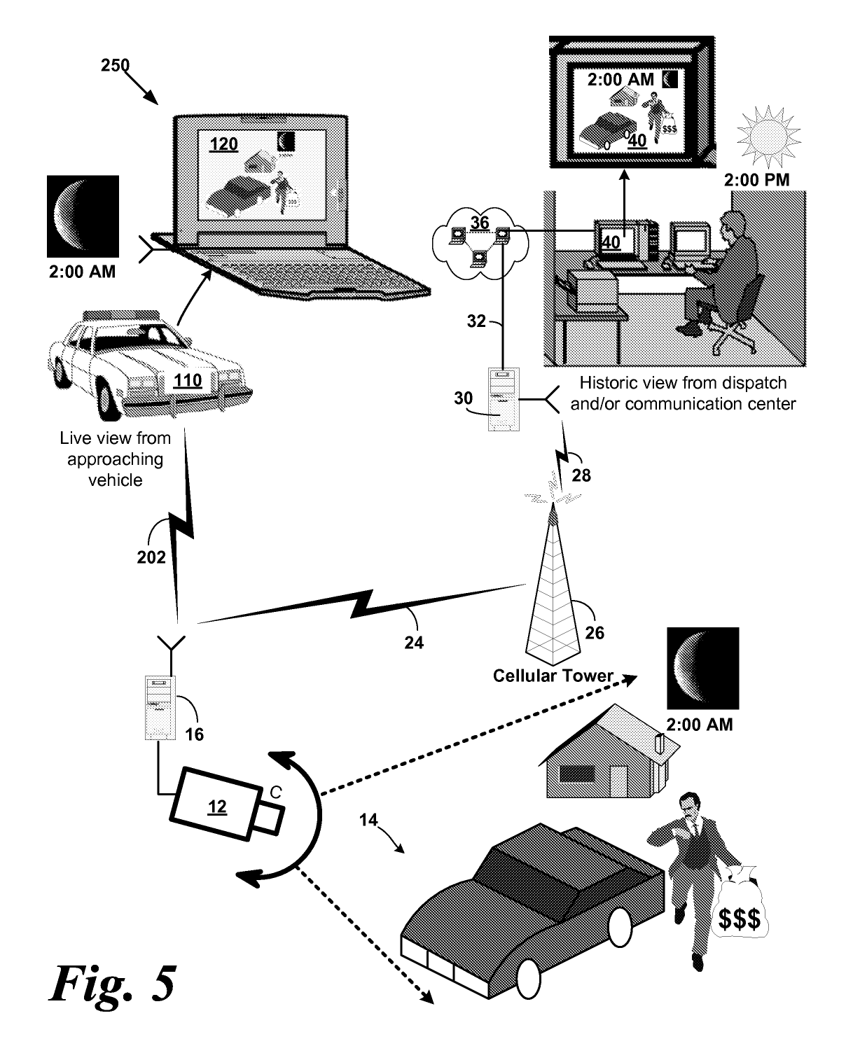

FIG. 5 pictographically depicts an alternate embodiment of a remote surveillance system having a view of a crime scene in two-way signal communication with mobile vehicles via non cellular-based wireless communication under a live viewing scenario, and cellular-based wireless, non cellular-based wireless, and wired communication with headquarters under an historic viewing scenario. System 250 includes a combination of System 200 and system 10 in which the police vehicle 110 communicates with the near-scene storage computer 16 to retrieve live images directly and independent of the cellular tower 26 via wireless signal 202, and the dispatch computer 40 receives historic (as depicted) or live digital images via the cellular tower 26 of the digital images of the crime scene or survielled space 14 via the near-scene storage computer 16 via wireless signals 24 and 28.

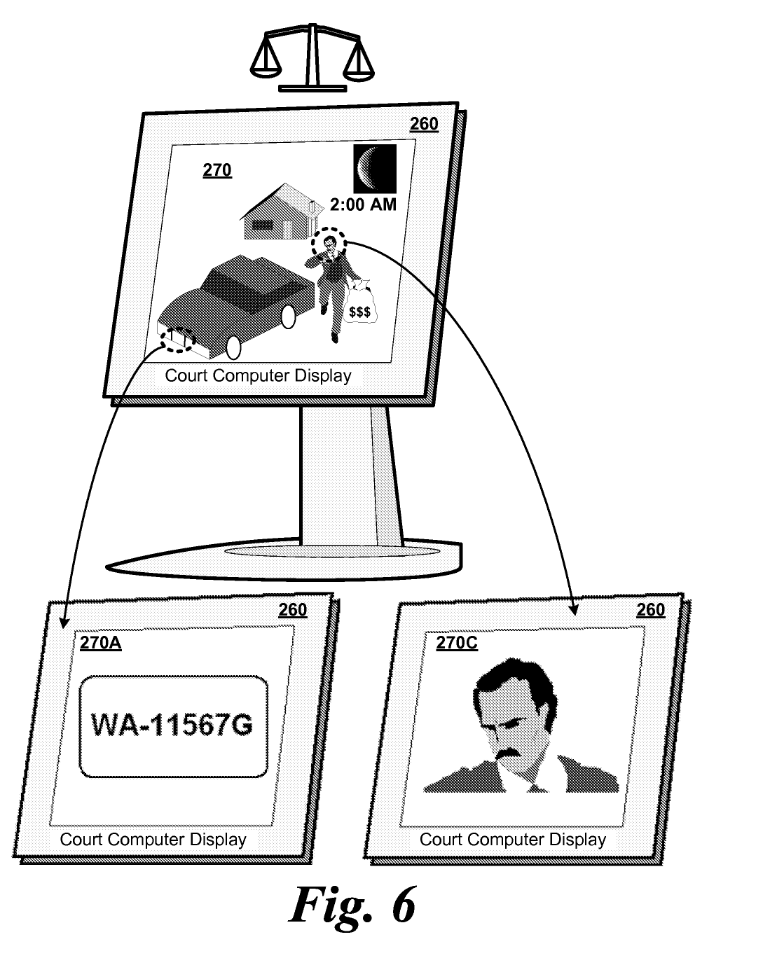

FIG. 6 pictographically illustrates a plurality of evidentiary displays obtained from digital files of the 2:00 AM crime scene. In the top display, the wide-angle presentation of the crime scene is shown with the suspected robber running from the house and approaching the getaway car on court computer display 260 as image 270. In the left lower panel, a magnification of the wide-angle digital file illustrates the getaway car's license number having sufficient resolution to read the alphanumerical characters to permit the identification of the getaway vehicle in image 270A. In the right lower computer display is a magnification of the fleeing suspect having sufficient clarity and resolution to meet facial identification standards in image 270B.

Using the particular embodiments of the remote surveillance systems, officers in the city, county, or regional jurisdictions will be able to call on an electronic partner to support observation of remote spaces.

Other embodiments of the remote surveillance system include the ability for an officer to easily deploy the video and/or audio portion of the system, to camouflage the video and supporting electronics as needed for discrete deployment so as to blend in with the area or space being surveilled, and to engage remote control of a cameras lens focus to impart manual control or resetting to auto-focus as desired. The field of view by the camera can include acute, oblique, hemispherical, and depending on camera placement, spherical views of the surveilled space. The deployed camera 12 and associated electronics can view any indoor, outdoor, or combination indoor and outdoor surveilled space. Set up is amenable to easy deployment and circuitry activated by an on-off switch.

Images obtained from the camera may be digitized and can include visible, infrared, and ultraviolet light sources and can be presented in color or black and white. The camera can be configured to operate under brightly lit circumstances and can include light amplification technology when ambient light is medium to low. The camera in certain embodiments will be able to zoom and read an auto license plate that is approximately 500 feet away the camera, and associated electronics can include potential tracking device, for example a global positioning satellite (GPS) apparatus in case of theft or misplacement. The GPS unit can share the antenna that supports the Wide Band Code Division Multiplexing (WCDMA) connection. The quality of the video can be set to evidentiary standards by headquarters, or as allowed, at standards other than evidentiary by the deploying officer. The video quality can also be set by remote control.

The TPZ camera 12 can be AC powered by 110 volts or other voltages available in local jurisdictions and can include a small DC powered battery to provide backup or supplemental support for AC power supplies. The auxiliary DC battery can preferably meet power requirements for the camera, transmitter, and supporting electronics for approximately 4-12 hours. The TPZ camera 12 and associated electronics and power supplies are constructed to operate within hazardous environmental conditions and not ignite flammable fuels during normal operation.

Digital storage media in communication with the TPZ camera 12 can be configured to store digital video and/or audio content of the surveilled space. The length of the digital recording within the digital storage media in communication with the TPZ camera 12 can be configured to store at least 4 hours of digital video and/or audio content of the surveilled space. Digital storage mechanisms within the TPZ camera 12 may be configured to store at least 8 hours of digital and/or audio content. Alternatively, the near-scene storage computer 16 may be configured to store at least 8 hours of evidentiary quality digital video and/or audio files. Variable recording rates are possible and may be selected to a desired frame per second (FPS). The desired frame rate can be between about 15 and about 60 FPS. When the surveilled scene exposes the camera to vibrations or other jarring actions, images acquired may be taken with motion or image stabilizing circuitry and devices associated with the camera.

Alternate embodiments of the remote surveillance systems include the TPZ camera 12 being capable of motion sensing activation. Camera activation can occur within approximately 1 minute of a sensed motion and to continue acquiring video and/or audio content approximately 5 minutes after motion sensing has ceased. The system may be able to trigger a software alert based on motion detection and motion detection settings and thresholds of the camera may be adjustable. The software may include motion detection alert notification protocols through an Application Program Interface (API) to support various alarm presets and thresholds. The camera may be configured with alarm presets that are communicated to headquarters' computer systems or to the laptops occupying the mobile vehicles.

The camera may also be configured to concentrate on regions of interest within the surveilled space by a center-on-click operation. Preset tours of the monitored space may be programmed remotely by precinct headquarters, the communications center, or via instructions conveyed by the software operating from laptops engaged by designated officers granted rights to take preset tours or otherwise remotely modify the preset tours by modifying any of the tilt, pan, and zoom operations of the camera. Depth of focus may also be remotely modified by headquarters or designated vehicle officers and varied with the regions of interest of the monitored space.

Alternate embodiments described above may utilize Application-Specific Integrated Circuits (ASIC) programmable with selectable code-decode (CODECs) standards. Encryption and security protocols may utilize at least 128 bit encryption (AES) with FIPS compliance to permit secure transmission from the TPZ camera 12 and/or near-scene storage computer 16 and precinct headquarters, the communication centers, and to those laptops 120 granted access rights occupying stationary or mobile vehicles 110/114.

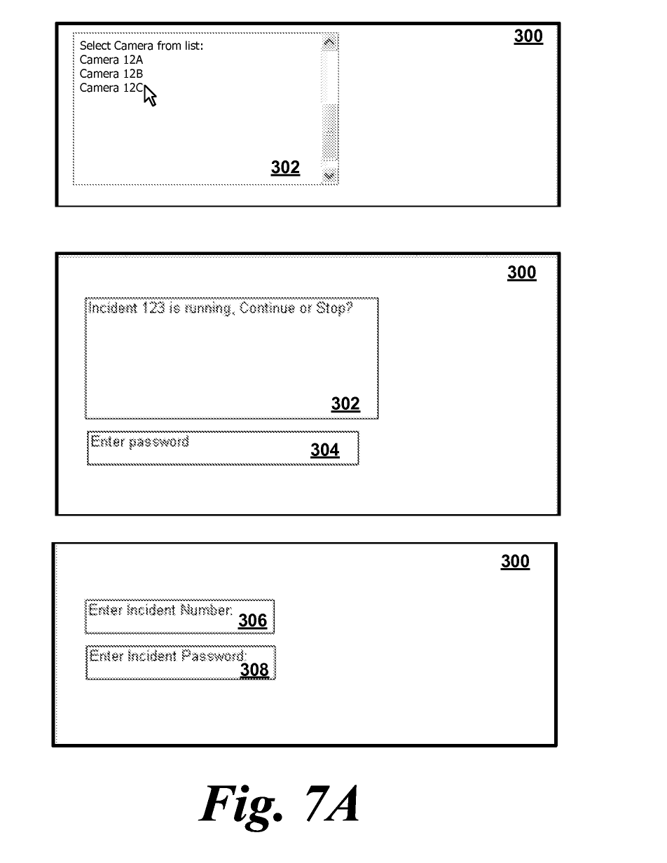

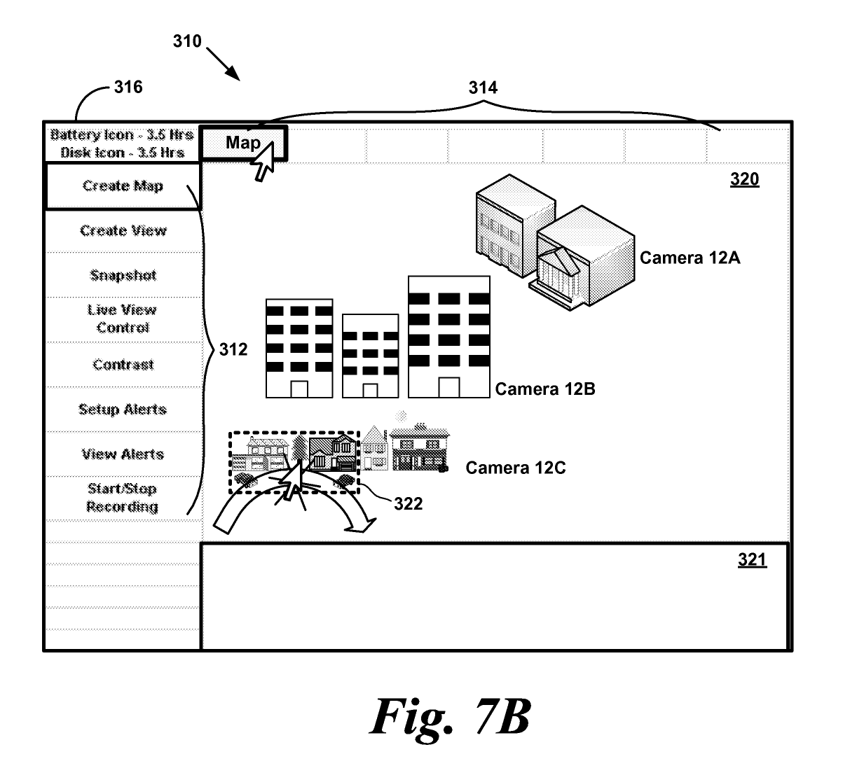

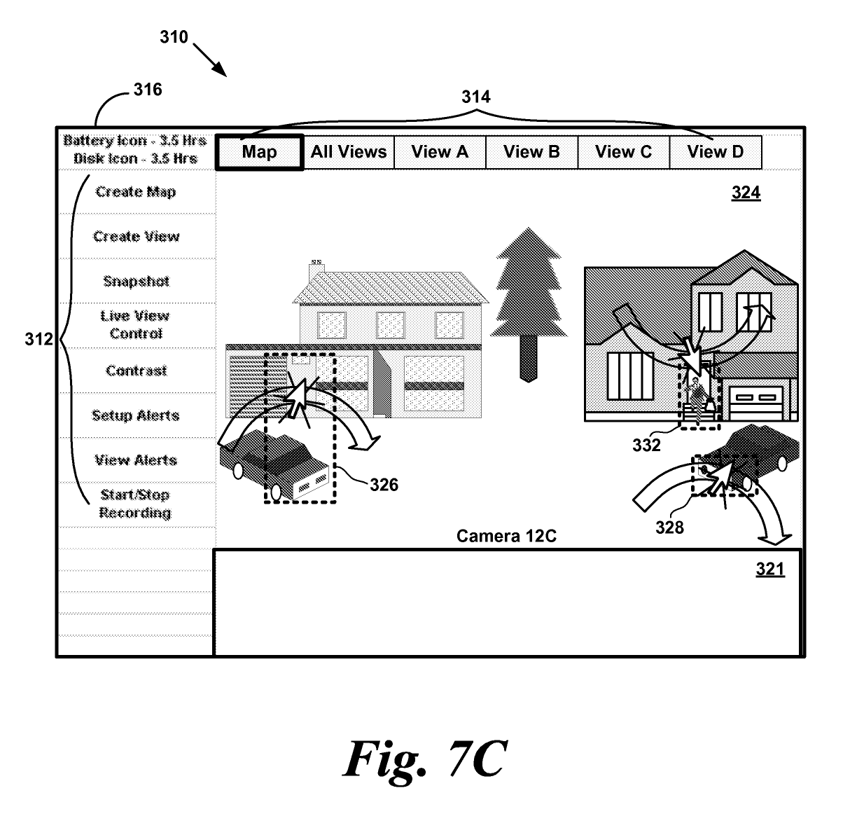

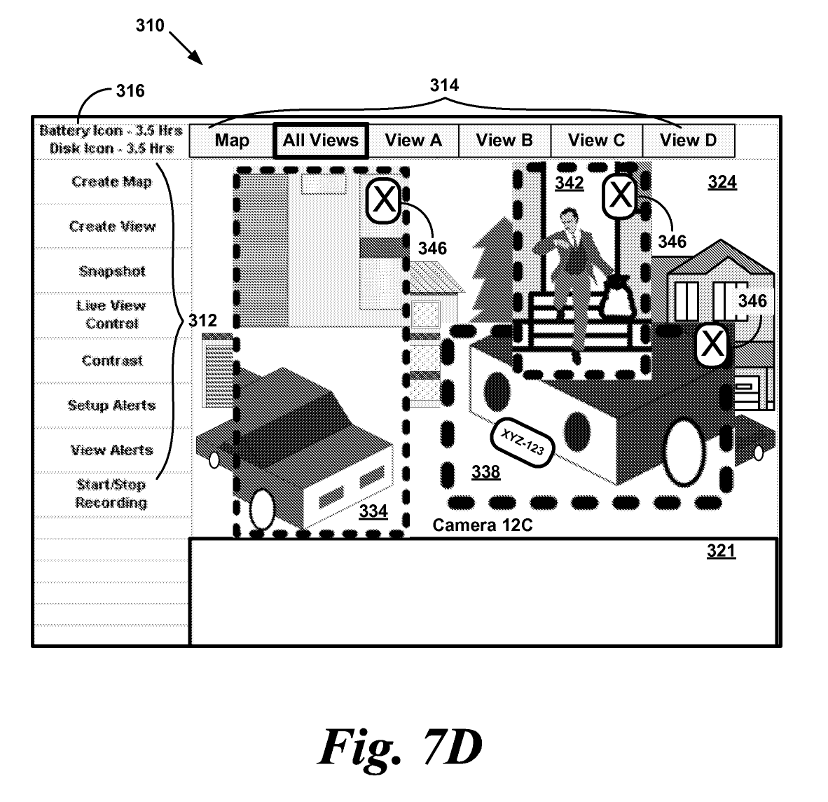

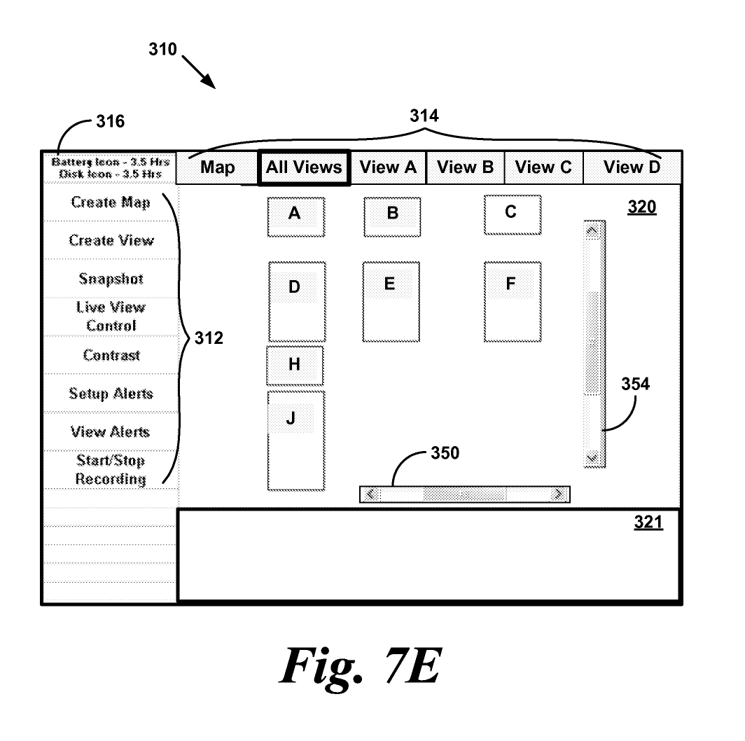

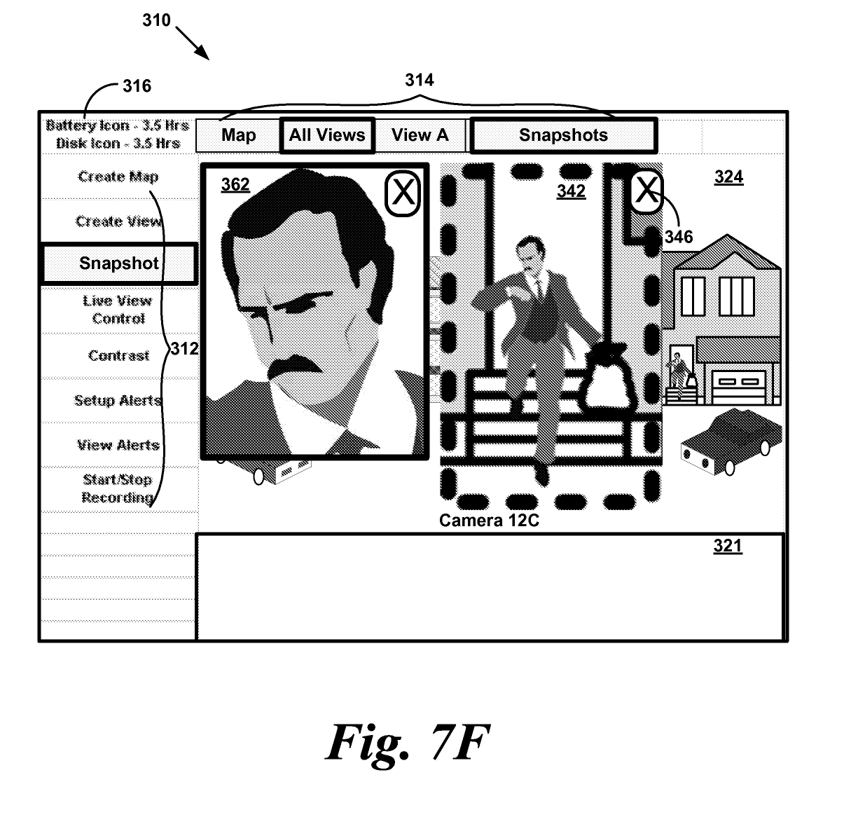

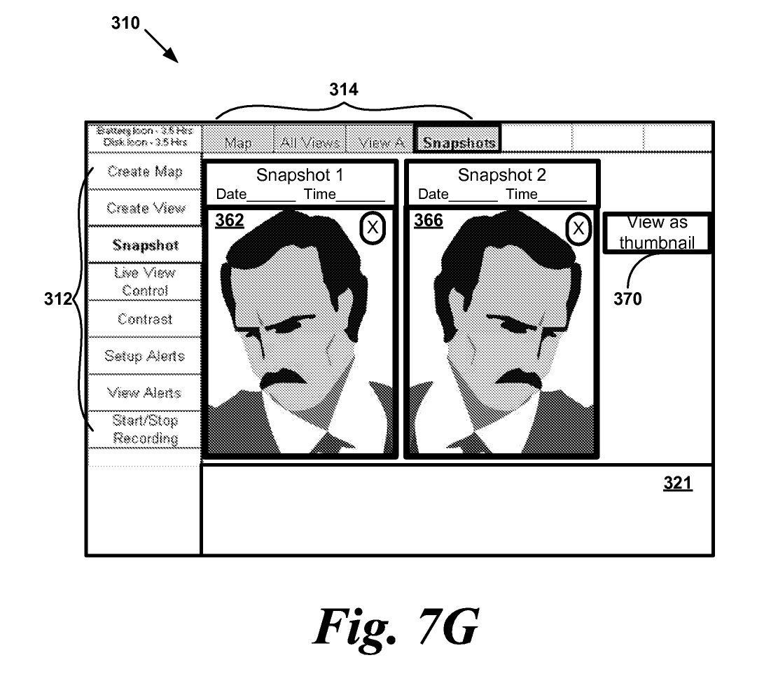

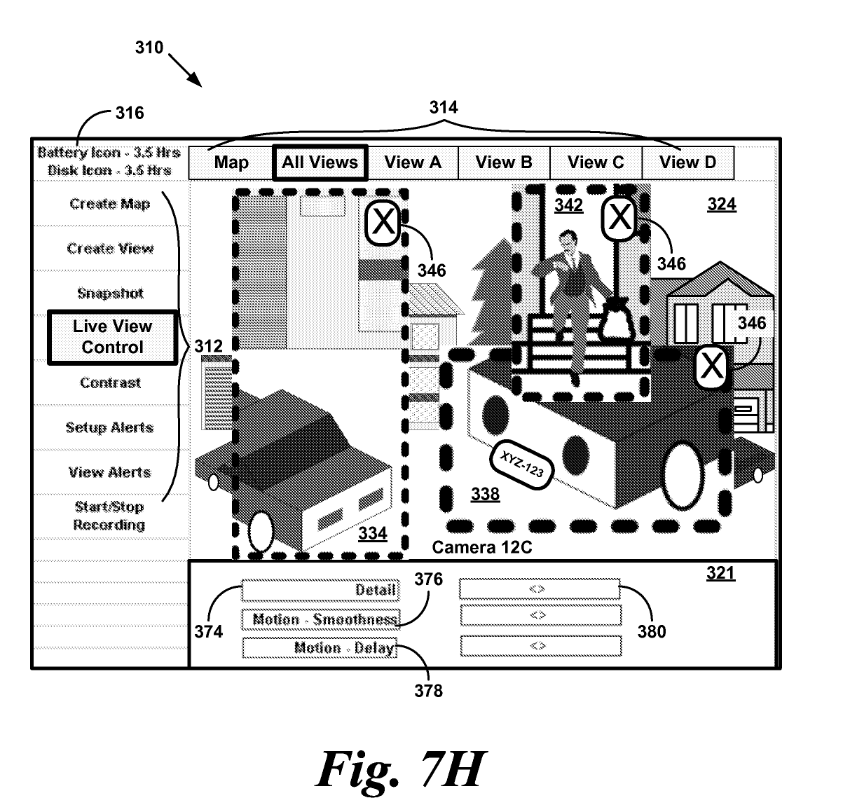

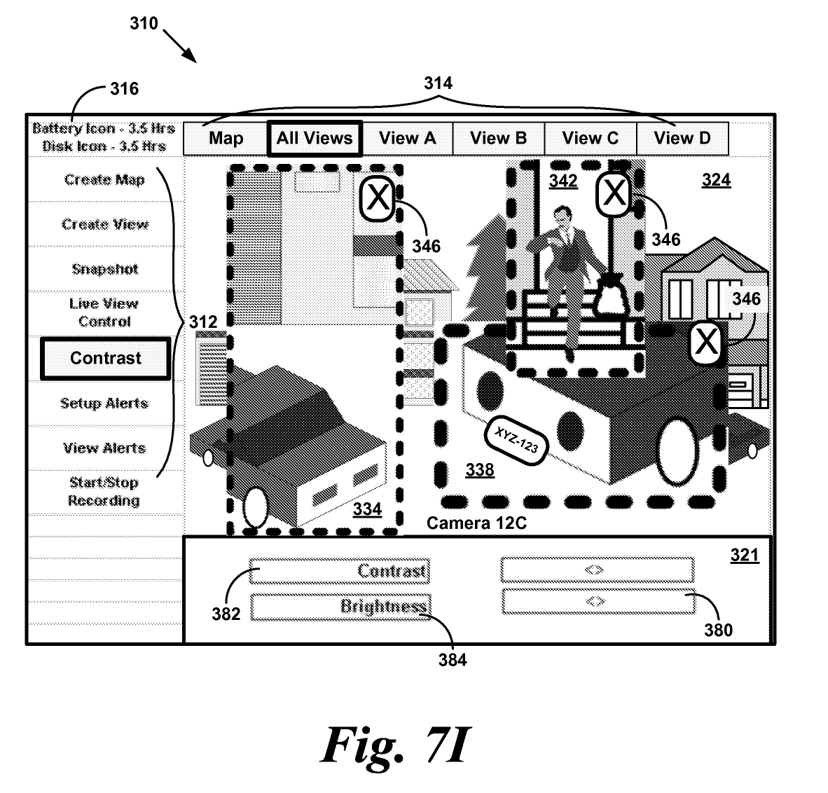

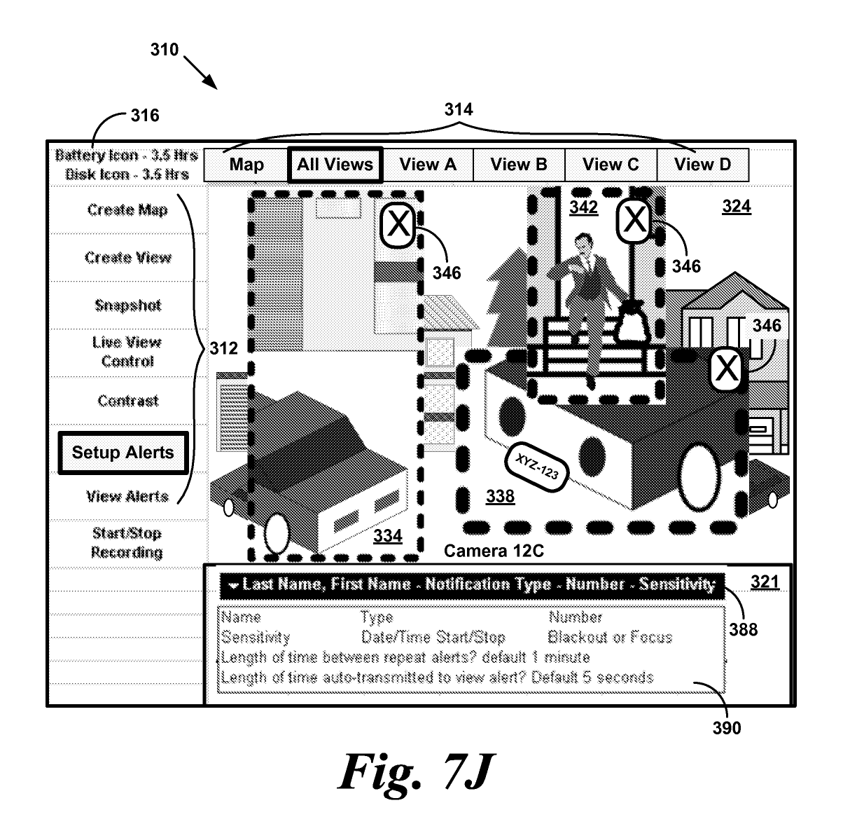

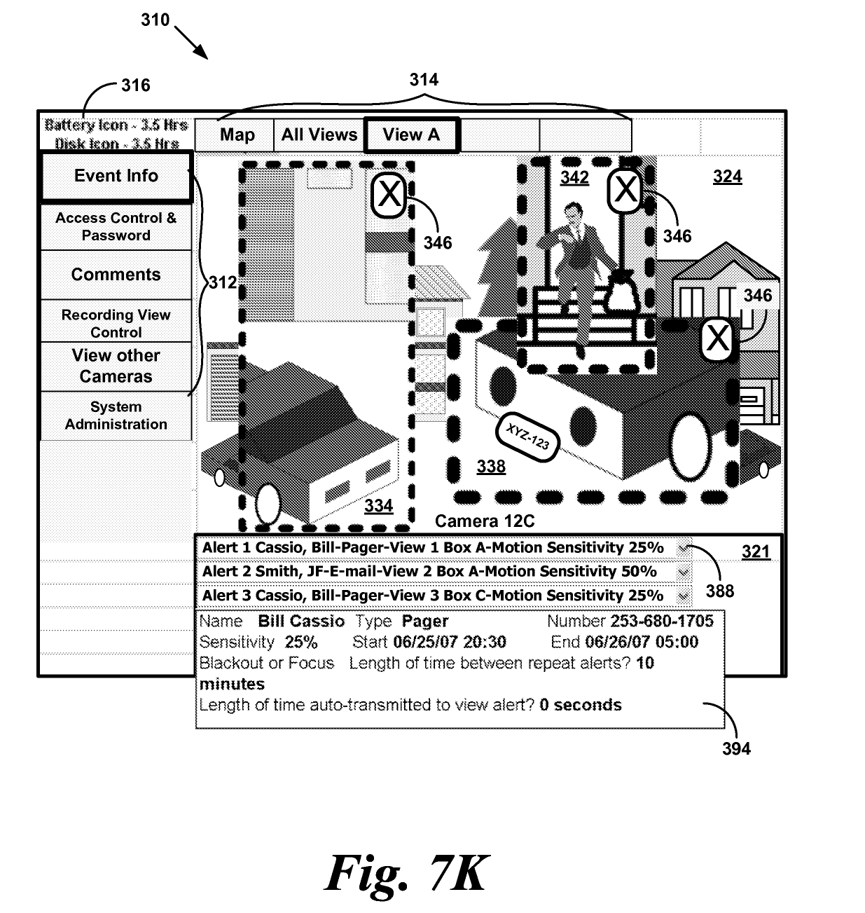

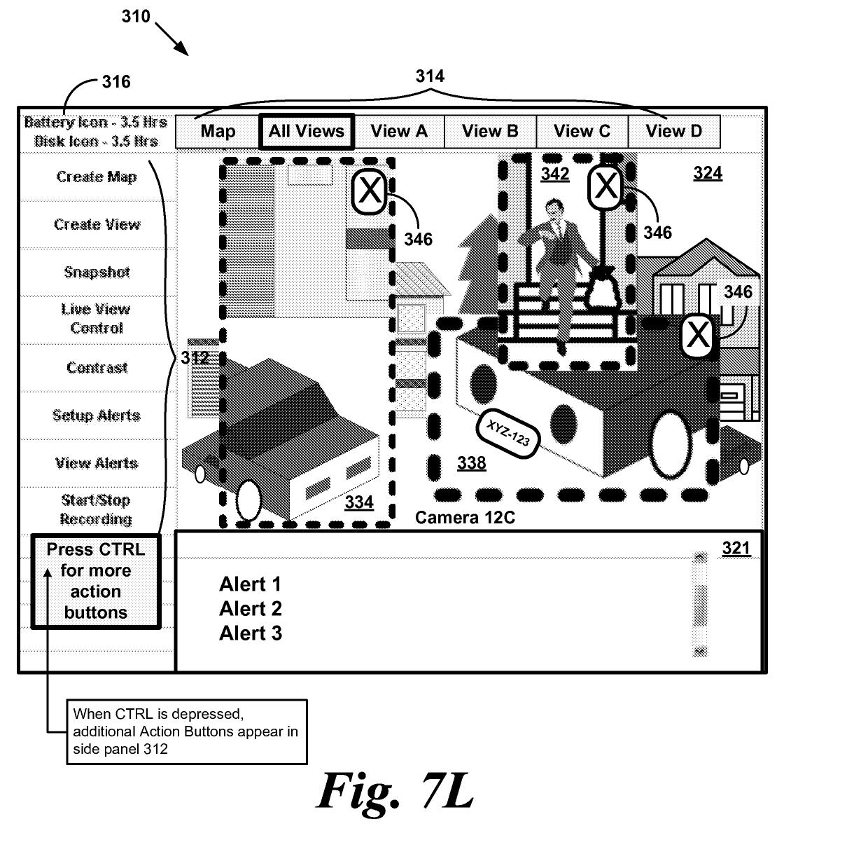

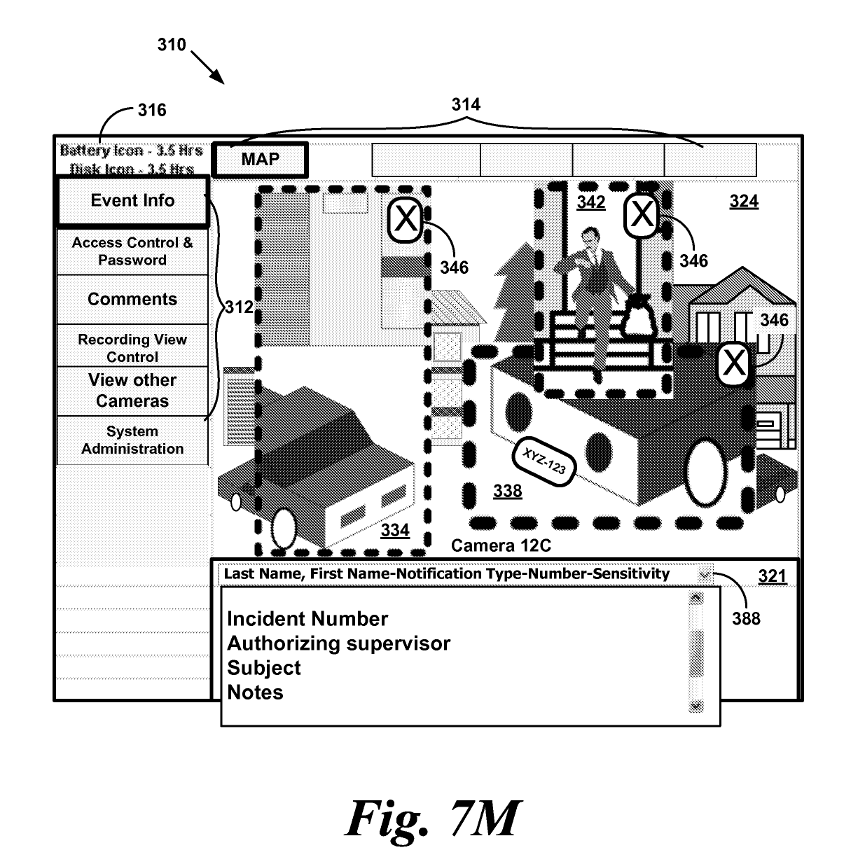

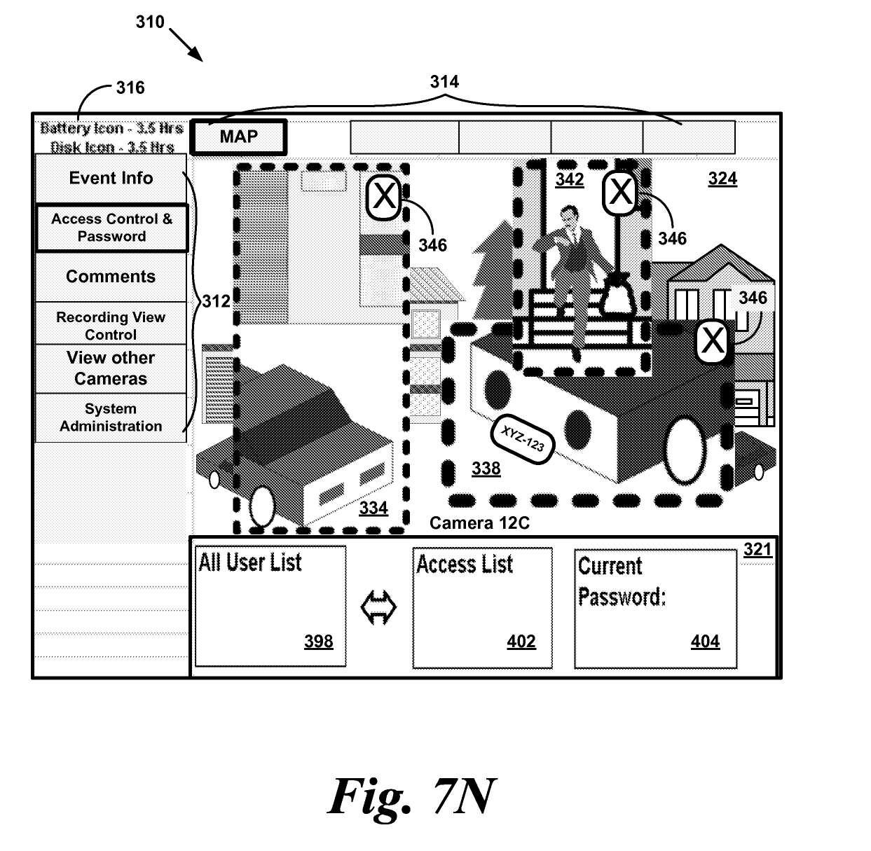

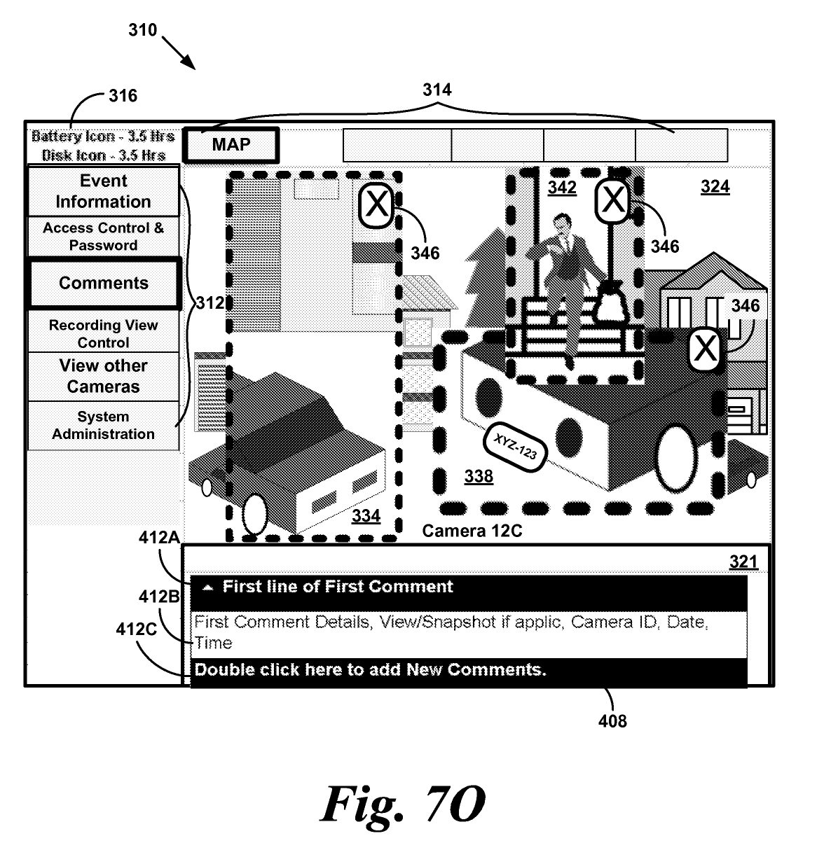

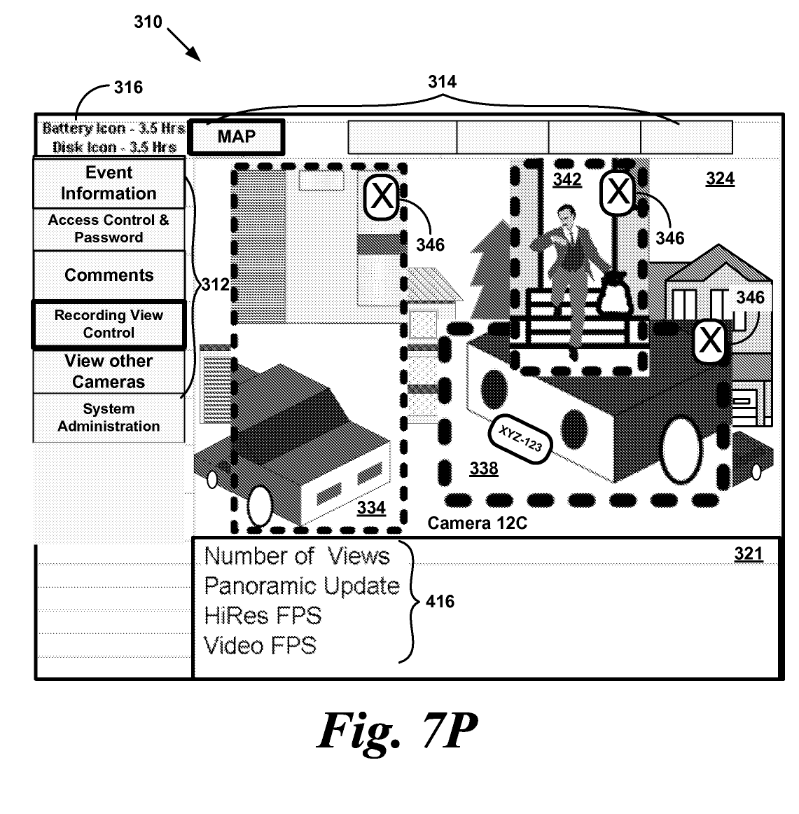

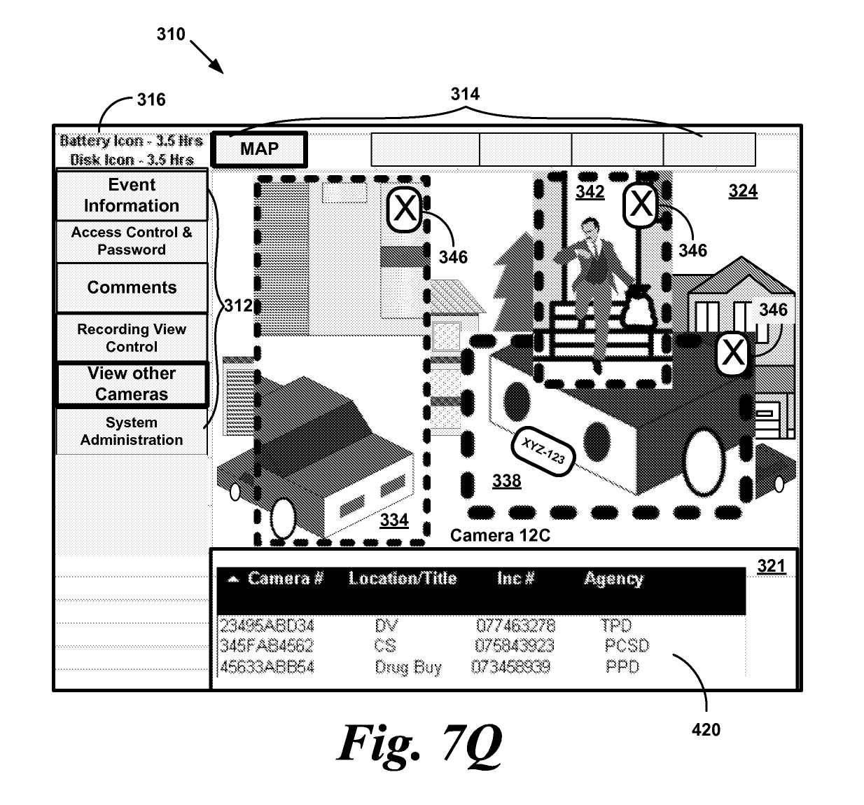

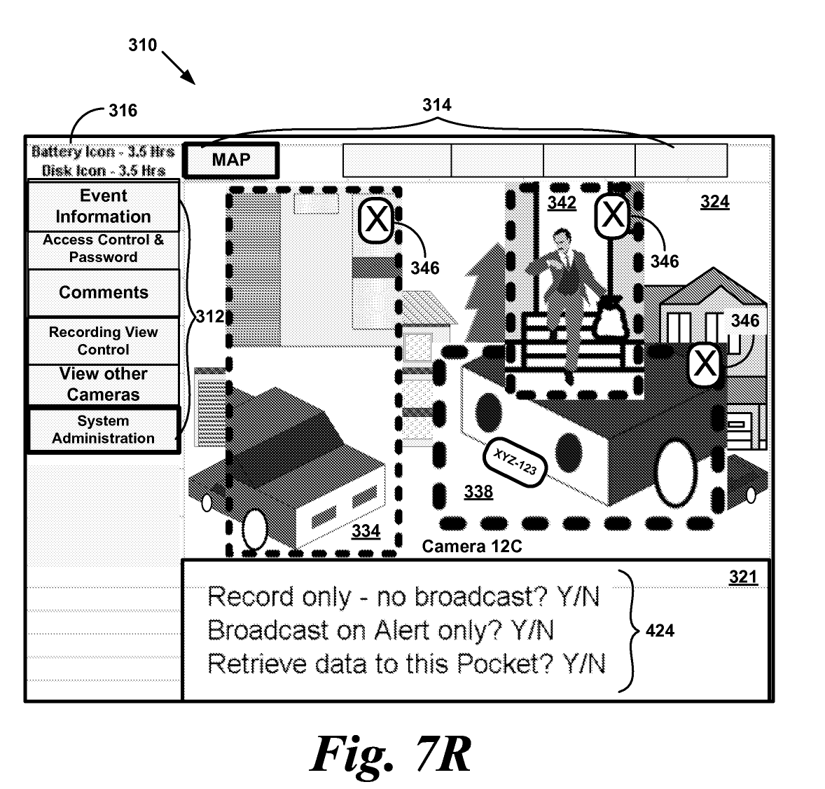

FIGS. 7A-7S depicts work-up screen shot templates for a portable computer interface.

FIG. 7A illustrates a top panel depicting an initial surveillance screen 300 that appears when an officers occupying police vehicles 110/114 activates the laptop computer 120. The surveillance screen 300 includes a surveillance scene listing window 302. A list of surveillance or crime scenes A, B, C similar to crime or surveillance scene 14 appear in the surveillance listing window 302. In this example, cameras 12 are located at surveillance scenes 14A, 14B, and 14C when cameras 12A, 12B, and 12C located at crime scenes 14A/B/C are within signal range of the laptop computer 120. If only cameras 12A/B are located at scenes A or B are within range, then cameras 12A and 12B are listed within the surveillance listing window 302. The user of laptop 120 then selects Camera 12C. Software instructions utilized by the laptop interfaces, respond to this user selection, as shown in the middle panel, and present a statement and query, “Incident 123 is running. Continue or Stop?” in listing window 302. If stop, a password prompt box 304 appears for entry by the user. Alternatively, the system Administrator's password may be entered as a password override. If no incident, an officer may be prompted for a new incident number and the new incident password. In the lower panel, an incident number box 306 and an incident password box 308 appear for respective entry of an incident number and incident password.

FIG. 7B illustrates a screenshot depicting images of business, city, and residential views within the respective field of view of cameras 12A, 12B, and 12C. The screenshot 310 includes battery & disk icon box 316, a side button panel 312 having multiple action buttons, a top horizontal button panel 314 having multiple action buttons, a map window 320, and a prompt window 321. The side button panel 312 includes buttons to issue commands including create map, create view, snapshot, live view control, contrast, setup alerts, view alerts, and start/stop recording. When a computer pointer or mouse interaction encages the Map button of horizontal panel 314, miniaturized versions of surveillance scenes 14 appear in screenshot 310 presented on laptop 120 in police vehicles 110 and 114 or any other computer screen in wireless or wired signal communication with camera 12 stationed at surveillance scene 14.

In this screenshot example, the map window 320 presents three lower-resolution images that may be engaged by subsequent computer-interface or pointer-movement actions, for example, a “mouse” interaction that can engage the whole lower resolution image or portions thereof. In map window 320 are three surveillance lower resolution images that depict miniaturized versions of surveillance scenes 14. A two-city building view is delivered by camera 12A, a three business-building view is delivered by camera 12B, and a four-residential building view is delivered by camera 12C. A pointer movement action 322 selects a region of interest for magnification and surveillance examination of residential view from camera 12C. In this example a view comprising two houses with nearby automobiles of the four-residential building view is delineated for expanded examination via mouse interaction in pointer movement action 322.

FIG. 7C illustrates the magnified two-house view 324 selected from pointer movement action 322 from FIG. 7B. Here, laptop-user-selected region-of-interest of the two-house view 324 is undertaken for further magnification and surveillance examination via pointer movement actions 326, 328, and 332. Pointer movement action 326 defines a region of interest having a dashed perimeter that encompasses the doorway of the left house and the rear portion of the left automobile. The pointer movement action 328 defines a region of interest having a dashed perimeter trunk region of the right automobile in front of the right house. The pointer movement action 332 defines a region of interest having a dashed perimeter capturing a person leaving the front door and walking down the steps of the right house.

FIG. 7D illustrates the magnified images of the regions of interest appearing in screenshot 310 from pointer movements 324, 326, and 332. The magnified images 334, 336, and 342 are presented at resolution levels sufficient to discern live or historic activity in sufficient detail to read license plate numbers or to recognize physical or facial features of a person of interest or suspect that is suitable to help establish identification. The magnified images 334, 336, and 342 include a closing box 346 to remove or erase the respective magnified images from the two-house view 324 of screenshot 310.

FIG. 7E depicts other region of interests A-J that can accumulate within screenshot 310 to warrant inclusion of horizontal 350 and vertical 354 scroll bars. Horizontal panel 314 expands with a larger button repertoire to accommodate the greater number of regions of interest from View A to View J. In this exemplary depiction of screen shot 310 having regions of interests A-J, all views, regions of interests appear as thumbnails that can be expanded by double clicking on them in pointer movements or actions to achieve expanded images having a first resolution image and subsequently, a second higher resolution image. Each first and second resolution image has a closing X box (not shown) similar to closing box 346 for erasing the expanded images. The first double click expands the thumbnail to a new window that may, for example, produce an image having a resolution of 160×120 pixels. Double clicking on this 160×120 pixel image expands it to an enhanced resolution of 320×240 pixels. Clicking on the X in the right hand corner of the windows containing the expanded images closes the respective expanded image windows.

FIG. 7F depicts an example of FIG. 7E in which screenshot 310 under snapshot mode presents two expanded regions with different pixel resolutions. The lower resolution 160×120 pixel image 342 overlaps the right house in window 324 and depicts a suspect leaving the front porch of the right house. The higher resolution 320×240 pixel image 362 illustrates a magnification of the lower resolution image 342 having sufficient clarity expansion to identity the facial features of the suspect.

FIG. 7G depicts an exemplary scenario wherein screenshot 310 provides two high resolution screenshots of video footage acquired from camera 12C. Here the first high resolution image 362 of the suspect and a second high resolution image 366 are respectively retrieved and stored respectively as Snapshot 1 and Snapshot 2. When a tab is active and the user presses the Snapshot button, a View Snapshot tab is created and a frame capture at that time is copied to the ‘View Snapshot’ tab. The Snapshot images are labeled with a unique identification number per the Incident event number and may have a resolution of 800×600 pixels. Each snapshot may have date and time entries related to the frame recording of the video footage. Snapshot 1 and 2 may be closed or re-presented as a thumbnail via thumbnail button 370. When the thumbnail button or toggle 370 is engaged, the high resolution images 362 and 366 can change to a Normal View. Scroll bars similar to horizontal 350 and vertical 354 scroll bars appear when too many thumbnail images are created to display within screenshot 310. Doubling clicking on Snapshots 1 or 2 creates other larger views in a separate window.

FIG. 7H depicts an exemplary modification of screenshot 310 to provided enhanced detail and motion manipulation. When All Views are highlighted and Live View Control is pressed, then slide bars Detail 374, Motion-Smoothness 376, and Motion-Delay 378 appear within prompt window 321, each slide bar having their respective spin buttons 380. If an individual tab is selected, then these slide bars apply only to that tab.

The slide bars 374, 376, and 378 dynamically adjust to each other. For example, when Detail 374 in increased, then Smoothness 376 is decreased and Delay 378 is increased. An option to freeze settings on one of the three slide bars is provided. If “Motion-Delay” 378 was considered to be critical to a given resource deployment, it may be frozen or fixed at a “0” or mid setting. By this freezing or fixing action, the remaining resources would be divided substantially equally between “Detail” 374 and “Motion-Smoothness” 376. Similarly, any adjustment between sliders 374 and 376 two sliders would have the inverse effect on the other slider.

FIG. 7I depicts an exemplary modification of screenshot 310 to provided enhanced contrast and brightness to selected regions of interest. When All Views are highlighted and Image Contrast is pressed, slide bars contrast 382 and Brightness 384 appear in the prompt window 321 along with respective spin buttons 380.

FIG. 7J depicts an example of establishing surveillance alerts. An officer can highlight a section of a view and click the Setup Alerts action button. Multiple alerts can be set up on a view, for example view 324, or multiple alerts may be set up for multiple magnified sub-views, for example sub-views, 334, 338, and 342. Under Setup Alerts, an ITEM BAR 388 appears in prompt window 321. The item bar 388 includes headings for last and first name of official, notification type, number, and surveillance sensitivity. Beneath the item bar 388 is a data entry block 390. The data entry black 390 includes categories for event Name (drop down from a given agencies' personnel table), Surveillance Type, Number of surveillance sessions, and Sensitivity level to trigger a surveillance session, the date and times for recording start and recording end for a given surveillance session, Blackout or Focus, entry of a length of time between repeat alerts with a default time of 1 minute being assigned should length of time between alerts not be set by the user, and an entry for a length of time for auto-transmission to view alert with a default of 5 seconds should the time for auto-transmission not be set. Once the first alert is set up, the default information for additional alerts may be the same as the previous alert. Pressing the control key CTRL brings up additional action buttons in side panel 312.

FIG. 7K depicts the screenshot 310 being further modified with multiple alert item bars 388 when Event Information action button is selected. Depicted are three exemplary item bars 388, each respectively leading with Alert 1 Cassio, Alert 2 Smith, and Alert 3 Casio, where Smith and Casio denote officers being notified who are responsible for responding to a given surveillance scene or monitored space 14. Within each item bar 388 are different communication modes, pager or email, and camera motion sensitivity levels, 25% or 50%. Beneath the Alert 3 Cassio item bar 388 is a data entry box 394 relevant to Alert 3. Data entry box includes multiple data entry fields. Pager communication protocol and telephone number are listed, data for blackout or active camera focusing for dates and times may be setup or modified, time between alerts, time for viewing auto-transmitted alerts, and surveillance start dates/time and surveillance end dates/times may be setup or edited by dispatch/communication center depicted in FIGS. 1 and 2. The data entry fields may include default parameters to set up the dispatch or communication center.

Alternatively, when hierarchical access is granted by the dispatch or communications center, an officer occupying the vehicles 110 and 114 may highlight a section of the map 324 and view surveillance scenes 14 having camera views 334, 338, and 342 and clicks the Setup Alerts action button depicted in FIG. 7K. Multiple alerts can be set up on a view by the officer in vehicles 110 or 114 and/or otherwise in possession of the computer 120.

FIG. 7L depicts a response scenario to incoming alerts announced by the computer 120. Screenshot 310 is modified by the officer manipulating the computer 120 upon hearing a ding or other aural or video announcement that alerts are incoming from at least one of the exemplary surveillance scenes discussed above. The officer clicks on View Alerts within side panel 312 and, by way of example, Alert 1, Alert 2, and Alert 3 appear within prompt window 321. The officer then may double click on one of the surveillance scenes 334, 338, and 342, and a second video control viewer opens in another window on one of these and can be taken to the date/time of the video when the alert was sent. Thereafter, about 5 seconds before and after the alert, the alert is off loaded to the laptop 120. The closing X box 346 may be engaged by the officer to close the full screen video of alert. Certain visual cues may be used to establish, at a glance, whether alert was examined. For example, the visual cues can be bold when not read, and un-bolded or normal when read or viewed by the Officer. Other computer pointer manipulations are available, including right clicking to turn off notifications from that camera/incident, to place the alerts in reverse order, to add a color highlight, for example a red highlight when alert scenarios of the images of the surveillance scenes 334, 338, and 342 are rendered as compressed or miniature images, for example, thumbnails.

FIG. 7M depicts a display of additional action buttons that appear in screenshot 310. Upon pressing the CTRL, in side button panel 312, additional action buttons that appear include Event Information, Access Control and Password, Comments, Recording View Control, View other Cameras, and System Administration. Within the prompt box 321 appears an action item bar 388 having entries for last name, first name, notification, case surveillance number, and surveillance sensitivity assignment. Beneath the item bar 388 are prompts for data entry concerning incident number, authorizing supervisor, subject, and notes. When the “Event Info” button is pushed the officer can edit the Incident Number (required in order to transmit the recording) and other descriptive detail. Subject, and Notes are optional editable fields. The User logs in and dates/times are captured, stored and may be unavailable to be edited. An authorizing supervisor may be selected from drop down list.

FIG. 7N depicts a modification of screenshot 310 to allow access to surveillance images and relevant information to other authorized users. When the officer selects and double clicks Access Control and Password action button in side panel 312, three boxes appear in the prompt window 321. The three boxes include All User List 398, Access List 402, and Current Password 404. Double clicking, or other computer interface interaction, on the All Users List box 398 transfers the names or coded names comprising the list of all users to the Access List box 402 which allows access to the names or coded names of the officials authorized to access the surveillance images and any relevant information thereto. Double clicking on the individual users within Access List 402 can be used to either remove them from the Access List 402, thereby removing access privileges. Alternatively, access rights may be selectively restricted to certain members occupying the Access List 402. For example, some members may be granted access only to images, and others only to non-image information. If no Access is set up, all users can have access. If any access is set up, the default may be to include the logged on officer as well.

FIG. 7O depicts a modification of screenshot 310 to allow authorized users to enter information and edit comments to information relevant to surveillance images and/or audio files. Engaging the Comments action button on side panel 312 creates a comments box 408 to appear within the prompt window 321. The comments box 408 comprises a series of item bars 412A-C to allow the entry and editing of entered commentary-based information. A top item bar 412A provides the space for a first line of a First Comment. A second item bar 412B provides a space for adding details to the first comment, for example the Camera ID number, the type of camera view, i.e., whether snapshot and/or video, the date, and the time. A third item bar 412C provides a space for new commentary and may be activated by double clicking with the human-computer interface. In such an arrangement, Item bars 412A-C are displayed for each completed Comment or a “New Comment” bar is used to create a new comment. Comments can point to Views, Snapshots, or General (i.e., not specific to a pointer on the video recording).

FIG. 7P depicts a modification of the screenshot 310 when the Recording View control action tab of panel 312 is engaged. Upon selecting the Recording View control tab, a data set 416 appears in prompt window 321. The data set 416 includes the Number of Camera views, a Panoramic Update, and advanced resource settings including a High Resolution (HiRes) frame per second (FPS) setting, and a Video frame per second setting. The advanced resource settings allow the officer to adjust and view the visual and potential impact of settings has on the view ability and evidentiary quality of the images. Values 3, Y, 3, and 15 may be used as default recording settings to memorialize surveillance scene or monitored space 14 activities. Other resource settings may be used as desired that are suitable to obtain evidentiary quality images and audio. Recording may be stopped in order to change these advanced resource settings.

FIG. 7Q depicts a modification of the screenshot 310 when the View Other Cameras action tab of panel 312 is engaged. Upon selecting the View Other Camera tab, a camera data table 420 appears in prompt window 321. The camera data table 420 includes a Camera identification number, a surveillance location and incident title, an incident number, and responsible or responding agency. In general the displayed cameras can be seen via 900 MHz communication. The officer may double click on the camera of interest and be prompted for the access password unless the officer is on the Access List 402 or the camera is unrestricted. The system administrator's password may work for securing access to the cameras.

FIG. 7R depicts a modification of the screenshot 310 when the System Administration action tab of the panel 312 is engaged. Upon selecting the System Administration tab, a data set 424 appears in prompt window 321. The data set 424 includes a Yes or No query for Record only without broadcasting, a Yes or No query for Broadcasting on Alert only, and a Yes or No query for retrieving data to this computer or pocket PC. Record only without broadcasting refers to the Watcher video recording the images but not broadcasting the recorded images. That is, it can only allow connection for management of the device. Broadcasting on alerts only refers to cases in which image data can only be sent when an alert is tripped. Retrieve Data to this Pocket may be set as a default and can be to transmit data only when Watcher cameras are within range of a 900 MHz server. This can be changed such that the Pocket or laptop 120 can be configured to retrieve data. In this mode, the Watcher can upload to the pocket or laptop 120, and not send it to the server.

FIG. 7S depicts an exemplary embodiment of a results screen 430. The results screen 430 includes tabular listings for surveillance incident number, the responsible police or governmental agency, date, surveillance subject matter, location, and responding officer. Clicking on columns selects names for sorting. Double clicking on rows can present a drill down procedure to new data windows having more details. Otherwise, the default sort is defined by incident number.

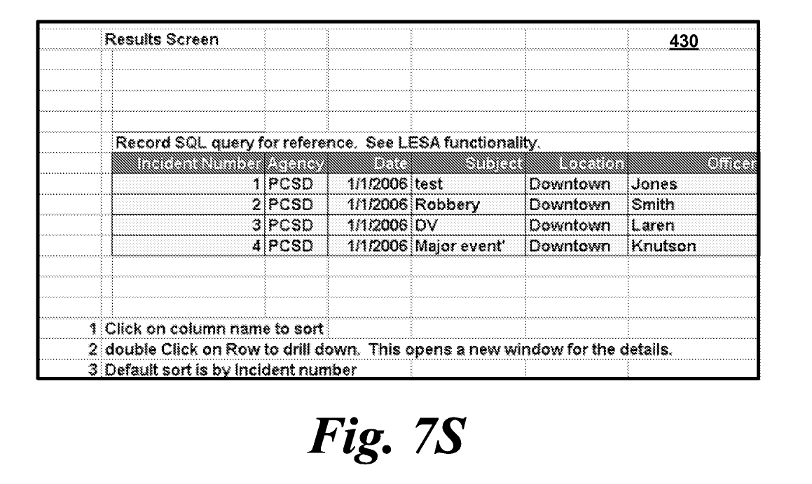

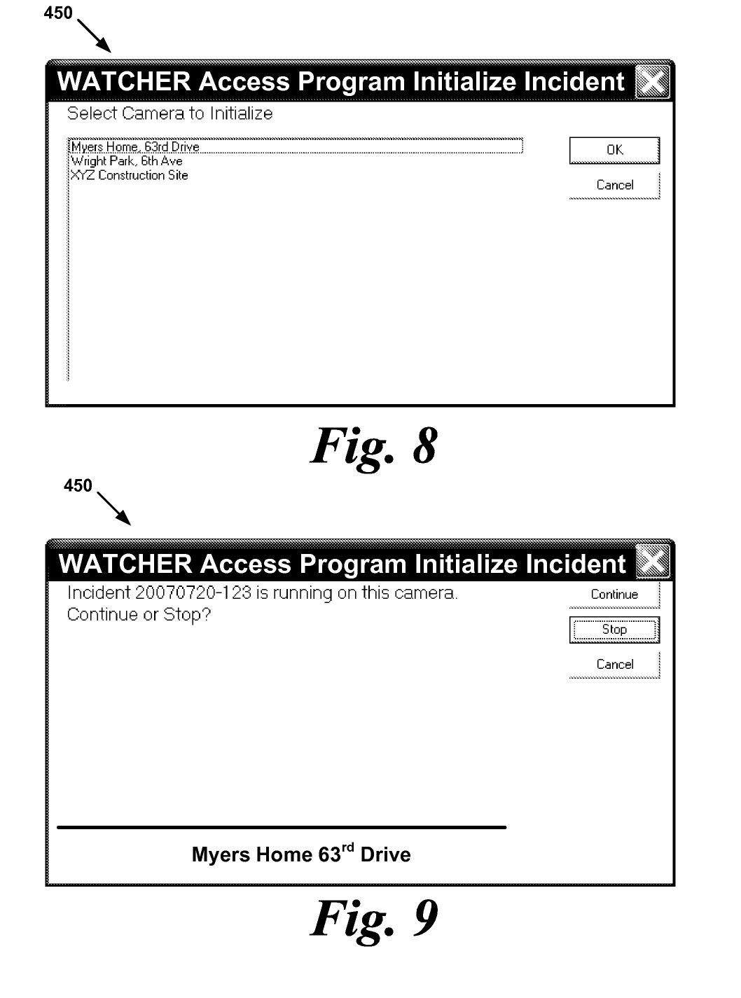

FIGS. 8-12 depict other particular screen shot embodiments using a WATCHER Access Program running on the computer 120 depicted in FIGS. 3-5 or computers 40 located at communication headquarters depicted in FIGS. 1, 2, and 5.

FIG. 8 is a WATCHER ACCESS PROGRAM Initialize Incident for selection of a Camera 12 to initialize. In this example, the Myers Home is the surveillance site 14.

FIG. 9 details an example of a stated incident number actively running on the Camera 12 at the Myers Home surveillance site 14. Within the screenshot is a query, “Continue or Stop”. Continue, Stop, or Cancel action buttons is then selected by the users of Computers 40 and/or 120.

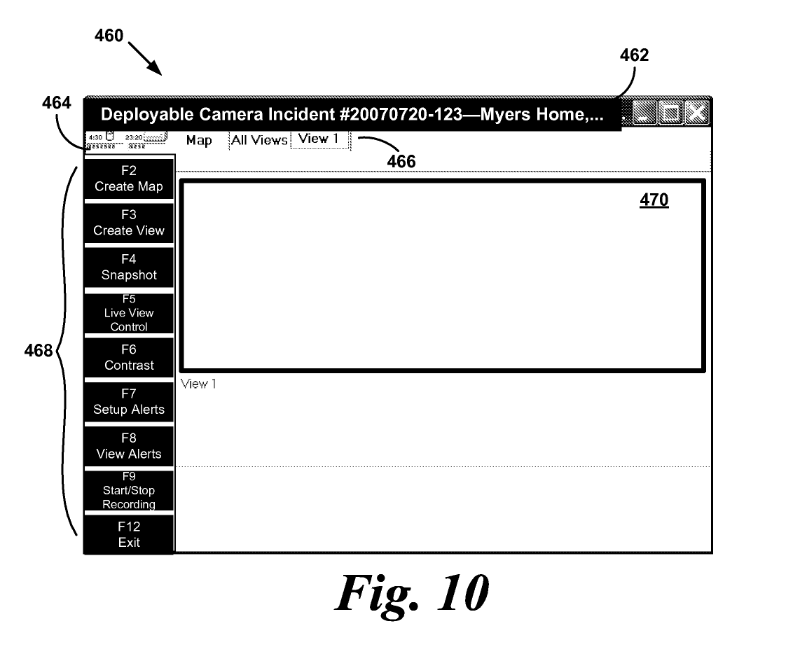

FIG. 10 depicts a screenshot 460 configured to acquire images and process images receivable from a surveillance site 14. Screenshot 460 includes a title bar 462, storage and save icons 464, horizontal action panel bar 466, a side action panel 468 having a plurality of action buttons executable by the function keys F2-F9 and F12 of the computer's 40 and/or 120 keyboard, and a view window 470 in which camera images can appear. The action buttons include F2—Create Map, F3—Create View, F4—Snapshot, F5—Live View Control, F6—Contrast, F7—Setup Alerts, F8—View Alerts, F9—Start/Stop Recording, and F12—Exit. Horizontal action bar 466 includes Map, All View, and View 1 action buttons. Here the title bar 462 reads “Deployable Camera Incident #20070720-123, Myers Home.”

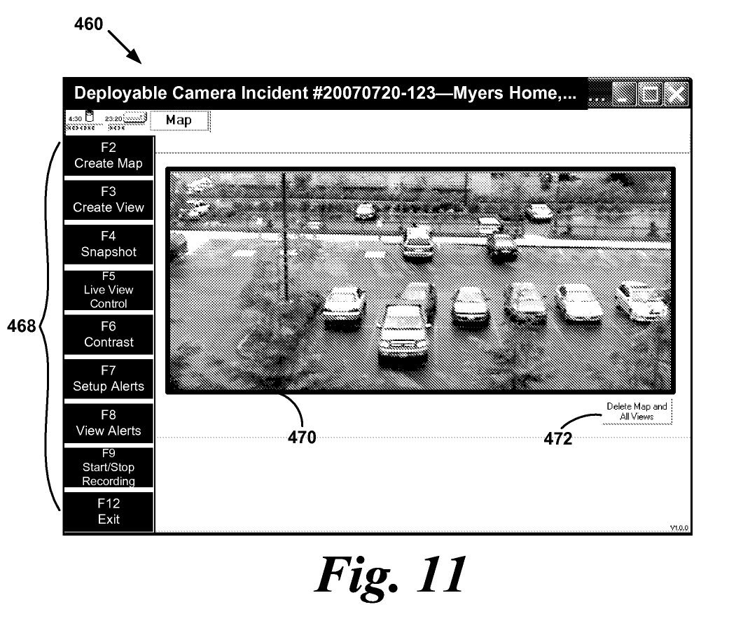

FIG. 11 depicts a modification of the screenshot 460 actively receiving video images from deployable camera 12 located at the surveillance site 14 concerning incident number 20070720-123. Here an image within the view window 470 displays a view of a parking lot with nine automobiles. When an image appears inside view window 470, a Delete Map/All Views button 472 appears within the screenshot 460.

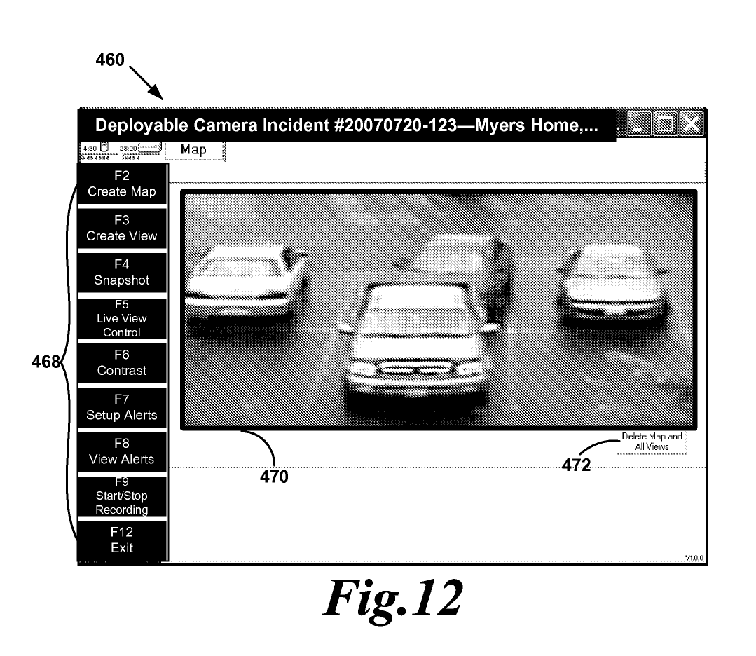

FIG. 12 depicts a further modification of the screenshot 460 in which snapshot of a region of interest of the image presented in FIG. 11 and displaying it in the view window 470. Here a close-up of four of the nine cars is displayed within the view window 470.

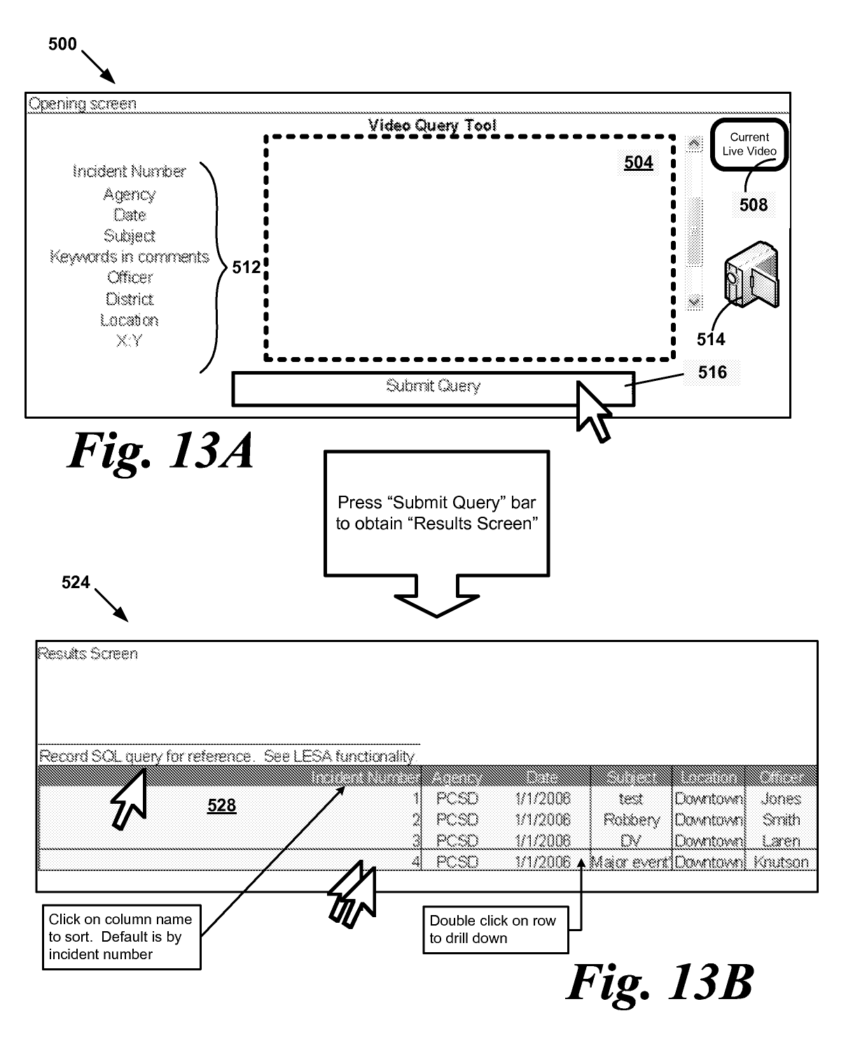

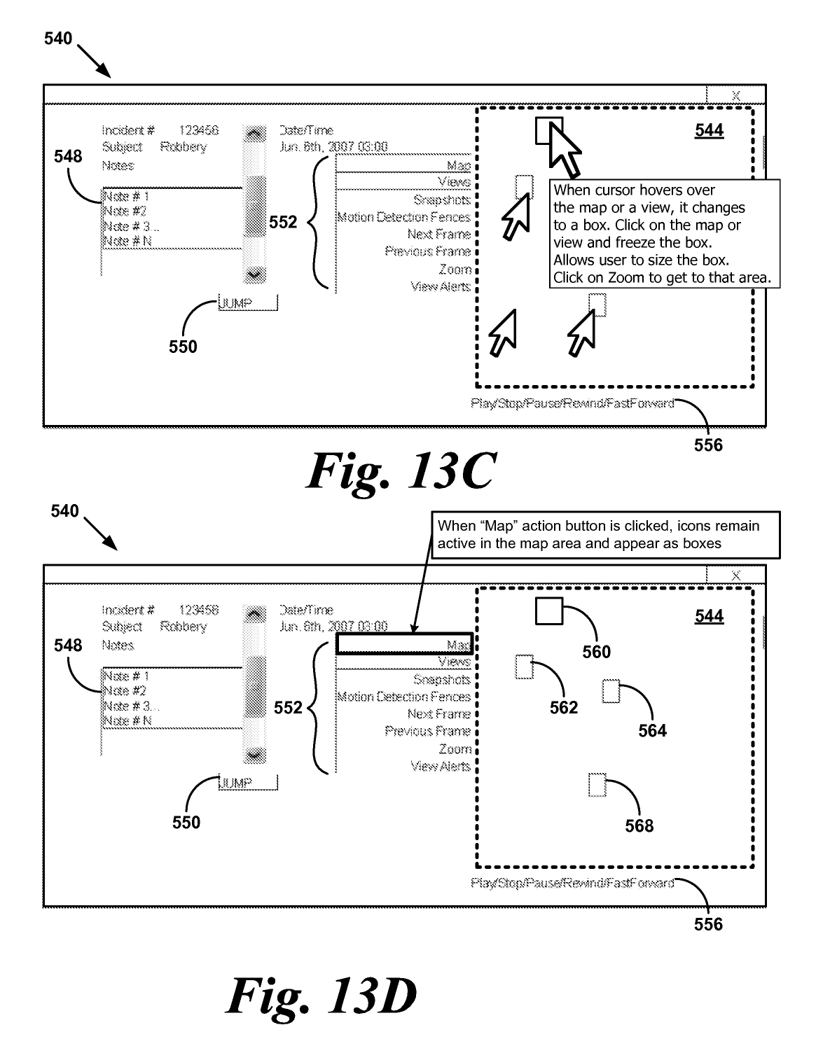

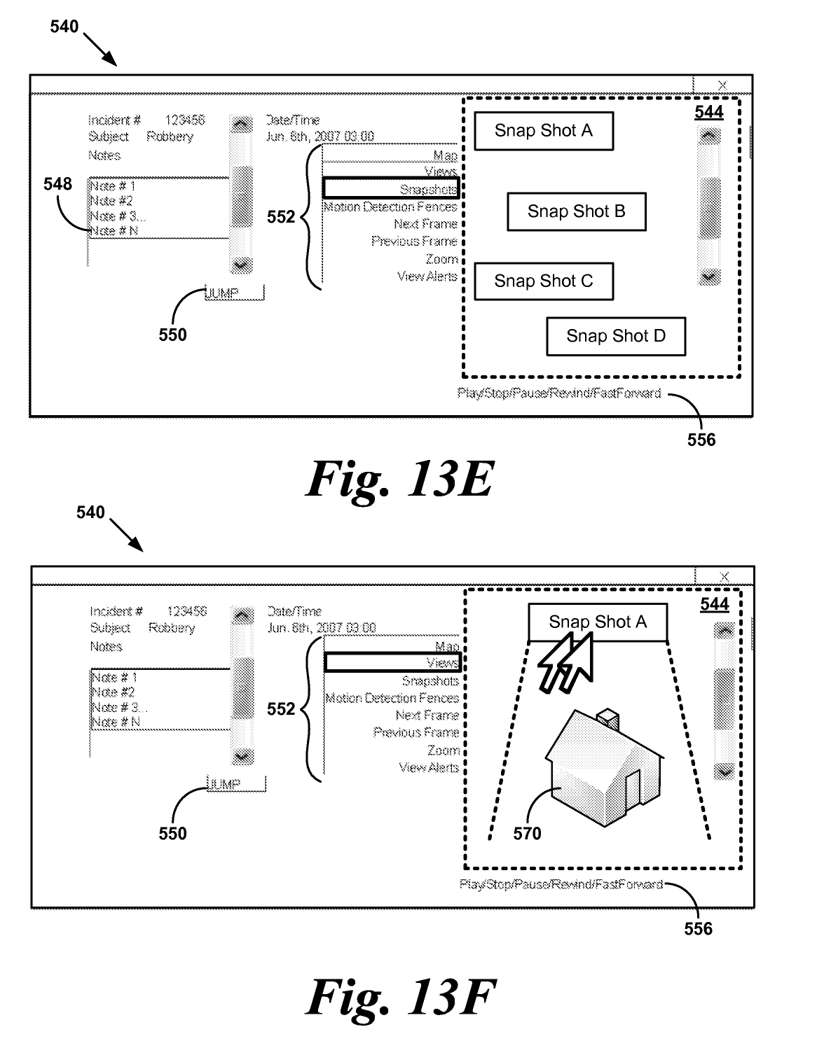

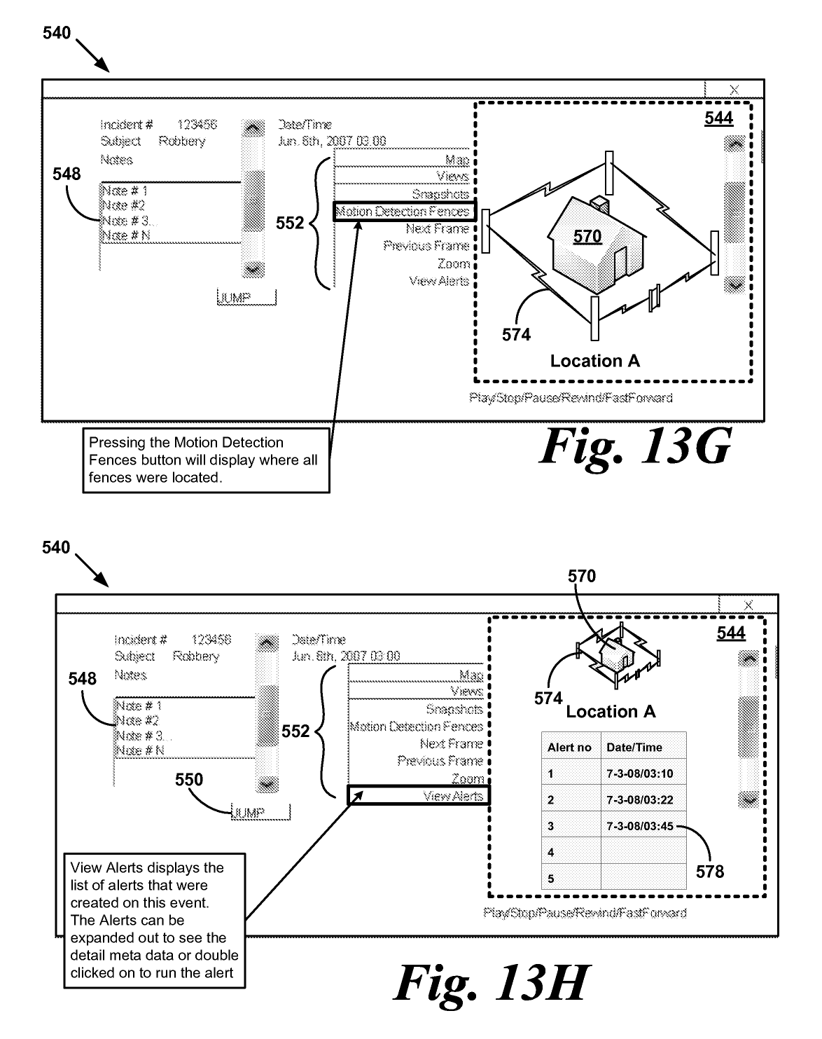

FIGS. 13A-13KJ depicts yet other screen shot embodiments for a browser interface.

FIG. 13A depicts a browser opening screenshot presenting a video query tool 500. The video query tool 500 includes a map window 504, a current live video tab 508, a side panel 512 of action buttons, a camera icon 514, and a submit query button 516. The side panel 512 includes action buttons incident number, agency, date, subject, keywords in comments, Office, District, Location, and Location coordinates in X & Y map based latitude and longitude dimensions.

The browser accessible video query tool 500 provides a host and internet explorer based tool to allow officers to set up and view cameras at surveillance scenes 14. The officer is presented a list of images in the database. When the camera icon 514 is present, the camera 14 at a given surveillance scene 14 is live and able to record and/or transmit audio/video images within its view. When the current live video tab 508 is pressed by an authorized officer, a live image of the surveillance scene 14 is presented within the map window 504. When the current live video tab 508 is pressed by an officer with restricted access rights, or anyone else without access rights, a message “Restricted-Contact Records” message appears within the map window 504. The submit query button 516 brings up a Results Screen when engaged by personnel having authorized access.

FIG. 13B depicts an exemplary Results Screen screenshot 524 upon engaging the submit query button 516. The Results Screen 524 presents alphanumeric data relevant to activity of a given surveillance scene 14. The alphanumeric data may be in the form of a table 528 having headings of incident number, agency, date, subject, location, and responsible or responding officer. Clicking on the column name provides a sorting action by incident number. Double clicking on a row provides a drill-down capability to receive other information windows that pop up having expanded details.

FIG. 13C depicts an embodiment of a Detail Screenshot 540. The Detail Screen shot 540 includes a map window 544, a note window with scroll bar 548, a Jump button 550, a side panel 552 of action buttons, a video control panel or play bar 556, and an exemplary plurality of surveillance scenes 14 denoted as map surveillance boxes 560, 562, 564, and 568. The note window 548 provides a note listing, each note capable of being expanded to read in its entirety by computer interface clicking. The jump button 550 calls existing date and time queries to a particular portion of map window 544. The side panel 552 includes action buttons map, views, snapshots, motion detection fences, next frame, previous frame, zoom, and view alerts. The video control panel 556 includes play, stop, pause, rewind, and fast forward.

FIG. 13D depicts additional details of FIG. 13C. When map action button is clicked on via the computer interface, the map window 544 is active. Views 560-568 of surveillance scenes 14 appear as box icons and may include miniaturized thumbnail images. When the map 544 is active, the play bar 556 may run at 4 frames per hour with panoramic maps.

FIG. 13E depicts a modification of the Detail Screenshot 540 when snapshot action button of side panel 552 is engaged. Upon clicking the Snapshot action button, a list of snapshots appears as thumbnails and a scroll bar if needed to move down the list within map window 544. In this example, Snap Shots A-D appears within map window 544. Double Clicking on a snap shot can fill the image window. Right clicking provides the option to save in JPEG or other designated image formats.

FIG. 13F depicts another modification of the Detail Screenshot 540 when Views action button of side panel 552 is engaged. Double clicking on Snap Shot A provides an expanded view that fills the window map 544. A surveillance image 570 appears within the window map 544.

FIG. 13G depicts another modification of the Detail Screenshot 540 when Motion Detection Fences action button of side panel 552 is engaged. Pressing the Motion Detection Fences button displays an electrified icon 574 of approximately where the motion detection fences are in relation to the surveillance image 570.

FIG. 13H depicts another modification of the Detail Screenshot 540 when View Alerts action button of side panel 552 is engaged. View Alerts displays the list of alerts that were created relating to surveillance image 570. The alerts can be expanded out to see the detail in a table 578 or double clicked on to run the alert. Next frame allows users to click forward through the frames. Previous frame allows user to click rearward through the frames. Zoom allows user to highlight an area and fill the screen with that area. The Jump button 550 calls existing date and time queries to a particular portion of the surveillance image 570. Export allows users to export the image in the window to MPJEG and/or JPEG file formats.

FIG. 13I depicts an alternative embodiment of a Detail Screenshot 590. Detail Screenshot 590 includes an expanded side panel 592 having additional action buttons and a dedicated Export button 594. The additional action button includes Future, Rerun motion, and Video Analytics searching.

FIG. 13J depicts an exemplary embodiment of a results screen 598. The results screen 598 presents currently live alphanumeric data related to the video images of surveillance scenes 14 relevant to activity associated with the video images. The alphanumeric data includes tabular listings for surveillance incident number, the responsible police or governmental agency, date, surveillance subject matter, location, responding officer, and camera 12 identification numbers. Clicking on columns selects names for sorting. Double clicking on rows can present a drill down procedure to new data windows having more details. Otherwise, the default sort is defined by incident number.

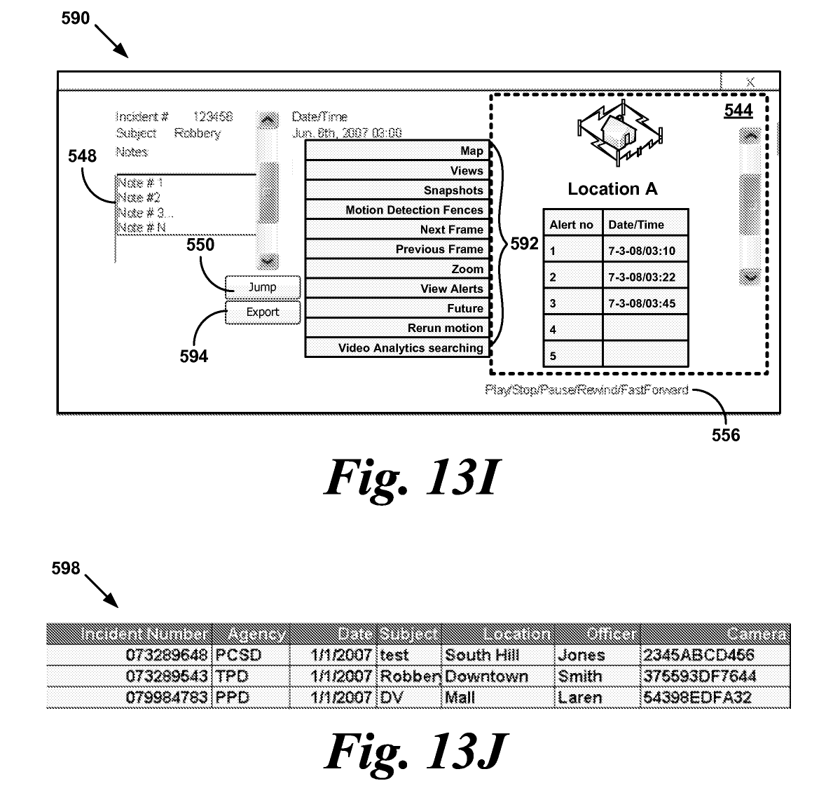

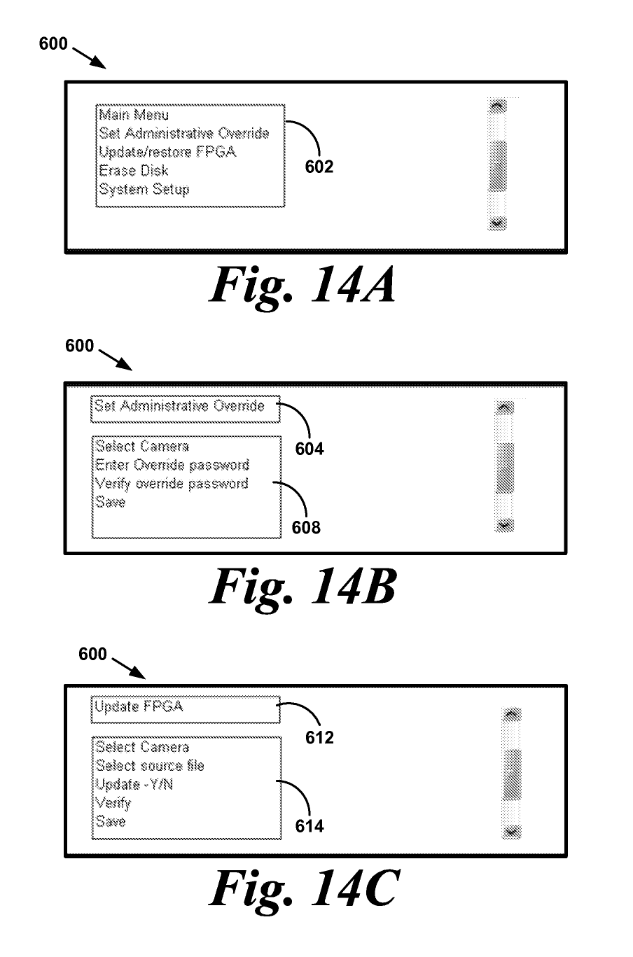

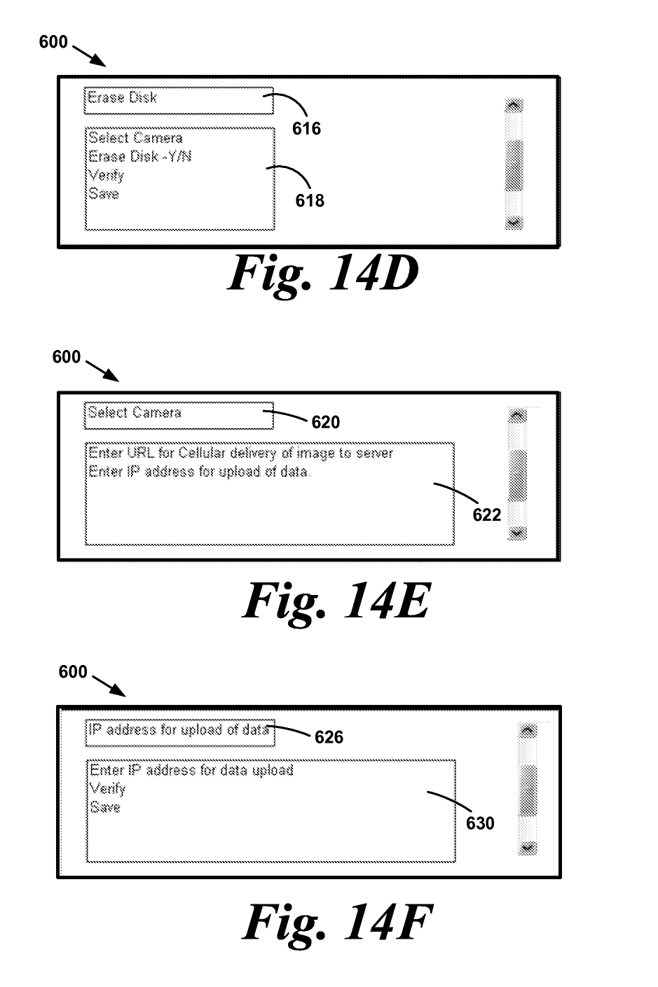

FIGS. 14A-14F depicts particular screen shot embodiments of a systems administrator user interface.

FIG. 14A depicts an exemplary embodiment of an administrative screenshot 600. The administrative screenshot 600 includes a Main Menu box 602. The Main menu box 602 includes clickable categories Main Menu, Set Administrative Override, Update/restore FPGA (Field Programmable Gate Array), Erase Disk, and System Setup.

FIG. 14B depicts a modification of the administrative screenshot 600 when Set Administrative Override 604 is selected. Upon selection, a Select Camera 608 box appears. The Select Camera box 608 includes a menu comprising select camera, enter override password, verify override password, and save.

FIG. 14C depicts a modification of the administrative screenshot 600 when Update FPGA (Field Programmable Gate Array) 612 is selected. Upon selection, a Select Source file box 614 appears with a menu list. The menu list includes select camera, select source file, Update—Yes or No, Verify, and Save.

FIG. 14D depicts a modification of the administrative screenshot 600 when Erase Disk 616 is selected. Upon selection, an Erase box 618 appears with a menu list. The menu list includes select camera, Erase Disk—Yes or No, Verify, and Save.

FIG. 14E depicts a modification of the administrative screenshot 600 when Select Camera 620 is selected. Upon selection, a Cellular delivery box 622 appears with a menu list. The menu list includes Enter URL (uniform resource locator address) for Cellular delivery of image to server and Enter IP (Internet Protocol) address for uploading of data.

FIG. 14F depicts a modification of the administrative screenshot 600 when IP Address 626 is selected. Upon selection, an IP address box 630 appears with a menu list. The menu list includes enter IP address for data upload, Verify, and Save.

While the preferred embodiment of the invention has been illustrated and described, as noted above, many changes can be made without departing from the spirit and scope of the invention. For example, the administrative screenshots may be configured to include access list hierarchies to limit access rights by at least one of officer rank, department, and inter-agency cooperation levels. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method to remotely monitor a space comprising:
installing at least one camera having a view of the space, the at least one camera being in signal communication with a first processor and configured to wirelessly communicate to at least one display having a second processor, the at least one display being remotely located from the space and in signal communication with a digital storage medium;
capturing substantially full motion video images of the space by the at least one camera;
converting the substantially full motion video images to an encrypted digital data stream using the first image processor;
wirelessly transmitting the encrypted digital data stream to the second image processor;
storing the transmitted, encrypted digital data stream in the digital storage medium;
decrypting the transmitted, encrypted digital data stream using the second processor to reform the substantially full motion video images; and
viewing the reformed, substantially full motion video images on the at least one display.

2. The method of claim 1, wherein capturing substantially full motion video images include image acquisition rates between about 15 and about 60 frames per second.

3. The method of claim 2, wherein capturing substantially full motion video images include frames having image information defined between about 0.5 and about 5 megabytes.

4. The method of claim 1, wherein converting the substantially full motion video images includes encoding image and any audio information contained in the video images into a format amenable to wireless transmission.

5. The method of claim 4, wherein encoding includes algorithms executable by the first microprocessor to preserve the digital data streams with the resolution necessary for evidentiary examination of the reformed full motion images.

6. The method of claim 5, wherein encoding the digital data streams includes applying an identifier stamp for establishing and auditing a chain of possession of the digital data streams.

7. The method of claim 1, wherein wirelessly transmitting the digital data streams is to a location separate from the space.

8. The method of claim 1, wherein viewing the reformed, substantially full motion video images by the at least one display includes an administrator display having hierarchal authority over other at least one display.

9. The method of claim 8, wherein the administrator display and the other at least one display have access to control the view of the at least one camera.

10. The method of claim 9, wherein the other at least one displays are located in at least one moveable vehicle.

11. The method of claim 10, wherein the at least one moveable vehicle is approaching the space.

12. The method of claim 9, wherein the other at least one display is held by at least one person capable to ambulate.

13. The method of claim 12, wherein the at least one person is ambulating toward the space.

14. The method of claim 8, wherein the administrator display and the other displays have access to currently transmitted encrypted data streams and historic encrypted data streams from the digital storage medium.

15. The method of claim 14, wherein the access to currently transmitted data streams and historic data streams is through a graphic user interface.

16. The method of claim 15, wherein the graphic user interface records a record to permit the auditing of access to the currently transmitted data streams and the historic data streams by the administrator display and the other at least one displays.

17. The method of claim 1, wherein storing the transmitted, encrypted digital data streams includes the digital storage medium being in close proximity to the at least one camera.

18. The method of claim 4, wherein the format amenable to wireless communication includes radio frequency transmission.

19. The method of claim 18, wherein radio frequency transmission is conveyed to at least one radio frequency receiver remotely located from the space.
